(19) United States
(12) Patent Application Publication
(10) Pub. No.: US 2022/0365317 A1
(43) Pub. Date: Nov. 17, 2022

(54) Optical Imaging Lens Assembly

(71) Applicant: ZHEJIANG SUNNY OPTICS CO., LTD., Ningbo, Zhejiang (CN)

(72) Inventors: Chen CHEN, Ningbo, Zhejiang (CN); Kaiyuan ZHANG, Ningbo, Zhejiang (CN); Biao XU, Ningbo, Zhejiang (CN); Fujian DAI, Ningbo, Zhejiang (CN); Liefeng ZHAO, Ningbo, Zhejiang (CN)

(21) Appl. No.: 17/772,514

(22) PCT Filed: Sep. 3, 2020
(86) PCT No.: PCT/CN2020/113226

§ 371 Date: Apr. 28, 2022

(30) Foreign Application Priority Data
Nov. 1, 2019 (CN) 201911061100.4

(51) Int. Cl. G02B 9/64

(52) U.S. Cl. CPC G02B 9/64

(57) ABSTRACT

The disclosure provides an optical imaging lens assembly, wherein the optical imaging lens assembly sequentially includes the followings from an object side to an image side along an optical axis: a first lens having a positive focal power, wherein an object-side surface thereof is a convex surface, and an image-side surface thereof is a concave surface; a second lens having a focal power; a third lens having a focal power; a fourth lens having a focal power; a fifth lens having a focal power; a sixth lens having a positive focal power; and a seventh lens having a negative focal power, wherein an object-side surface thereof is a concave surface, and an image-side surface thereof is a concave surface. DT11, DT12 and ImgH meet:2.4<(DT11+DT12)/lmgHx5<2.7.

### Cross-Reference to Related Present Invention(s)

The disclosure claims priority to and the benefit of Chinese Patent Disclosure No.201911061100.4 filed in the China National Intellectual Property Administration (CNIPA) on 1 Nov. 2019, which is incorporated herein by reference in its entirety.

### TECHNICAL FIELD

The disclosure relates to the field of optical elements, and more particularly, to an optical imaging lens assembly.

### BACKGROUND

In recent years, with the rapid development of mobile phone shooting technology, the application of the optical imaging lens assembly in mobile phones is increasing. Major terminal manufacturers have gradually put forward more and more requirements for lens specifications. Especially, the main camera of high-end flagship models is increasingly showing the development trend of large imaging surface and high aperture. Meanwhile, as the phone gets thinner, the market requires the built-in optical imaging lens assembly of mobile phones to be more compact and thinner.

### SUMMARY

According to an embodiment of the disclosure, an optical imaging lens assembly is provided, wherein the optical imaging lens assembly sequentially includes the followings from an object side to an image side along an optical axis: a first lens having a positive focal power, wherein an object-side surface thereof is a convex surface, and an image-side surface thereof is a concave surface; a second lens having a focal power; a third lens having a focal power; a fourth lens having a focal power; a fifth lens having a focal power; a sixth lens having a positive focal power; and a seventh lens having a negative focal power, wherein an object-side surface thereof is a concave surface, and an image-side surface thereof is a concave surface.

In an embodiment, DT11 is a maximum effective radius of the object-side surface of the first lens, DT12 is a maximum effective radius of the image-side surface of the first lens, and ImgH is a half of a diagonal length of an effective pixel region on an imaging surface of the optical imaging lens assembly, DT11, DT12 and ImgH meet: 2.4<(DT11+DT12)/ImgHx5<2.7.

In an embodiment, ImgH meets: ImgH>6.2 mm.

In an embodiment, a refractive index N1 of the first lens and a refractive index N2 of the second lens meet:N1+N2>3.3.

In an embodiment, TTL is a distance from the object-side surface of the first lens to the imaging surface of the optical imaging lens assembly on the optical axis and ImgH meet:TTL/ImgH<1.25.

In an embodiment, an Abbe number V1 of the first lens and an Abbe number V2 of the second lens meet: 78<V1+V2<88.

In an embodiment, a total effective focal length f of the optical imaging lens assembly, an effective focal length f1 of the first lens, an effective focal length f6 of the sixth lens, and an effective focal length f7 of the seventh lens meet: 0.5<f/(f1+f6+f7)<1.0.

In an embodiment, a curvature radius R1 of the object-side surface of the first lens, a curvature radius R2 of the image-side surface of the first lens, a curvature radius R3 of an object-side surface of the second lens, and a curvature radius R4 of an image-side surface of the second lens meet: 0.3<(R1+R2)/(R3+R4)<0.8.

In an embodiment, the effective focal length f7 of the seventh lens, a curvature radius R13 of the object-side surface of the seventh lens, and a curvature radius R14 of the image-side surface of the seventh lens meet: 0.2<f7/(R13−R14)<0.6.

In an embodiment, FOV is a maximum field of view of the optical imaging lens assembly meets:

82°<FOV<88°.

In an embodiment, a distance T45 between the fourth lens and the fifth lens on the optical axis, a distance T56 between the fifth lens and the sixth lens on the optical axis, a distance T67 between the sixth lens and the seventh lens on the optical axis, a center thickness CT5 of the fifth lens on the optical axis, a center thickness CT6 of the sixth lens on the optical axis, and a center thickness CT7 of the seventh lens on the optical axis meet 0.8<(T45+T56+T67)/(CT5+CT6+CT7)<1.2.

In an embodiment, at least one of the first lens to the seventh lens is made of glass.

An optical imaging lens assembly provided in the disclosure includes several lenses, for example, a first lens to a seventh lens. The optical imaging lens assembly will be more compact and thinner, and have the features of high aperture and large imaging surface by reasonably setting the relationship of maximum effective radius of the object-side surface of the first lens, maximum effective radius of the image-side surface of the first lens, and ImgH and optimizing and reasonably combining focal power and surface type of the lenses.

### BRIEF DESCRIPTION OF THE DRAWINGS

Other features, objectives and advantages of the disclosure will become more apparent through the detailed description of non-limiting embodiments with reference to the drawings. In the drawings:

FIG. 1 shows a structure diagram of an optical imaging lens assembly according to Embodiment 1 of the disclosure;

FIGS. 2A to 2D show a longitudinal aberration curve, an astigmatic curve, a distortion curve, and a lateral color curve of the optical imaging lens assembly according to Embodiment 1 respectively;

FIG. 3 shows a structure diagram of an optical imaging lens assembly according to Embodiment 2 of the disclosure;

FIGS. 4A to 4D show a longitudinal aberration curve, an astigmatic curve, a distortion curve, and a lateral color curve of the optical imaging lens assembly according to Embodiment 2 respectively;

FIG. 5 shows a structure diagram of an optical imaging lens assembly according to Embodiment 3 of the disclosure;

FIGS. 6A to 6D show a longitudinal aberration curve, an astigmatic curve, a distortion curve, and a lateral color curve of the optical imaging lens assembly according to Embodiment 3 respectively;

FIG. 7 shows a structure diagram of an optical imaging lens assembly according to Embodiment 4 of the disclosure;

FIGS. 8A to 8D show a longitudinal aberration curve, an astigmatic curve, a distortion curve, and a lateral color curve of the optical imaging lens assembly according to Embodiment 4 respectively;

FIG. 9 shows a structure diagram of an optical imaging lens assembly according to Embodiment 5 of the disclosure;

FIGS. 10A to 10D show a longitudinal aberration curve, an astigmatic curve, a distortion curve, and a lateral color curve of the optical imaging lens assembly according to Embodiment 5 respectively;

FIG. 11 shows a structure diagram of an optical imaging lens assembly according to Embodiment 6 of the disclosure;

FIGS. 12A to 12D show a longitudinal aberration curve, an astigmatic curve, a distortion curve, and a lateral color curve of the optical imaging lens assembly according to Embodiment 6 respectively;

FIG. 13 shows a structure diagram of an optical imaging lens assembly according to Embodiment 7 of the disclosure;

FIGS. 14A to 14D show a longitudinal aberration curve, an astigmatic curve, a distortion curve, and a lateral color curve of the optical imaging lens assembly according to Embodiment 7 respectively;

FIG. 15 shows a structure diagram of an optical imaging lens assembly according to Embodiment 8 of the disclosure;

FIGS. 16A to 16D show a longitudinal aberration curve, an astigmatic curve, a distortion curve, and a lateral color curve of the optical imaging lens assembly according to Embodiment 8 respectively;

FIG. 17 shows a structure diagram of an optical imaging lens assembly according to Embodiment 9 of the disclosure;

FIGS. 18A to 18D show a longitudinal aberration curve, an astigmatic curve, a distortion curve, and a lateral color curve of the optical imaging lens assembly according to Embodiment 9 respectively;

FIG. 19 shows a structure diagram of an optical imaging lens assembly according to Embodiment 10 of the disclosure;

FIGS. 20A to 20D show a longitudinal aberration curve, an astigmatic curve, a distortion curve, and a lateral color curve of the optical imaging lens assembly according to Embodiment 10 respectively;

### DETAILED DESCRIPTION OF THE EMBODIMENTS

For a better understanding of the disclosure, various aspects of the disclosure will be explained in more detail with reference to the drawings. It should be appreciated that the detailed description of exemplary embodiments of the disclosure is not intended to limit the scope of the disclosure. In the Specifications, the same number in drawings refers to the same component. The expression “and/or” includes any and all combinations of one or more of the listed items associated.

In the Specifications, terms “first”, “second” and “third” are merely for distinguishing one feature from another and are not to be construed as any restrictions on features. Therefore, a first lens discussed below may also be referred to as a second lens or a third lens without violation to the instructions of the disclosure.

In the drawings, the thickness, size and shape of lenses have been slightly exaggerated for convenience of explanation. Specifically speaking, shapes of the spherical or aspheric surfaces shown in the drawings are illustrated by way of example. That is, shapes of the spherical or aspheric surfaces are not limited to the ones shown in the drawings. The drawings are illustrative only and are not drawn strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have the same meanings as those in the context of a related art and may not be explained with ideal or excessively formal meanings, unless clearly defined like this in the disclosure.

It should be noted that, in the absence of a conflict, embodiments of the disclosure can be combined with features in the embodiments. The disclosure will be described in detail below with reference to the drawings and in conjunction with embodiments.

The features, principles and other aspects of the disclosure are described in detail below.

According to exemplary embodiments of the disclosure, an optical imaging lens assembly may include, for example, seven lenses with focal powers, i.e., a first lens, a second lens, a third lens, a fourth lens, a fifth lens, a sixth lens, and a seventh lens. The seven lenses fall into place from an object side to an image side along an optical axis. There may be air space between adjacent lenses.

In an exemplary embodiment, the first lens can have a positive focal power, wherein an object-side surface thereof is a convex surface, and an image-side surface thereof is a concave surface; the second lens can have a positive focal power or a negative focal power; the third lens can have a positive focal power or a negative focal power; the fourth lens can have a positive focal power or a negative focal power; the fifth lens can have a positive focal power or a negative focal power; the sixth lens can have a positive focal power; and the seventh lens can have a negative focal power, wherein an object-side surface thereof is a concave surface, and an image-side surface thereof is a concave surface. The aberration of the optical system can be effectively balanced and the imaging quality can be improved by reasonably combining focal power and surface type of lenses in the optical system.

In an exemplary embodiment, an image-side surface of the fifth lens is a concave surface. In an exemplary embodiment, an object-side surface of the sixth lens is a convex surface.

In an exemplary embodiment, DT11 is a maximum effective radius of the object-side surface of the first lens, DT12 is a maximum effective radius of the image-side surface of the first lens, and ImgH is a half of a diagonal length of an effective pixel region on an imaging surface of the optical imaging lens assembly, DT11, DT12 and ImgH meet: 2.4<(DT11+DT12)/ImgHx5<2.7. Maximum effective radius of the object-side surface of the first lens, maximum effective radius of the image-side surface of the first lens, and the ratio of the sum of maximum effective radius of the object-side surface of the first lens and maximum effective radius of the image-side surface of the first lens to ImgH is a half of a diagonal length of an effective pixel region on an imaging surface of the optical imaging lens assembly are reasonably set, which is not only beneficial to reasonably control the uniform shape transition of the first lens and the reliability of subsequent lens forming and assembly, but also beneficial to reasonably limit the incident range of light. In this way, the refraction angle of light in the first lens is relatively small, thus reducing the off-axis aberration and reducing the system sensitivity.

In an exemplary embodiment, ImgH is a half of a diagonal length of an effective pixel region on an imaging surface of the optical imaging lens assembly, ImgH meets: ImgH>6.2 mm. Setting ImgH according to the above conditions is beneficial to realize large imaging surface and high aperture of the lens and allows the optical imaging lens assembly group to have higher resolution.

In an exemplary embodiment, a refractive index N1 of the first lens and a refractive index N2 of the second lens meet:N1+N2>3.3. Reasonable setting of the refractive index of the first lens and the second lens is beneficial to improve the performance of the optical system.

In an exemplary embodiment, TTL is a distance from the object-side surface of the first lens to the imaging surface of the optical imaging lens assembly on the optical axis, TTL and ImgH meet:TTL/ImgH<1.25. Reasonable setting of the ratio of the distance from the object-side surface of the first lens to the imaging surface of the optical imaging lens assembly on the optical axis to the half of the diagonal length of the effective pixel region on the imaging surface of the optical imaging lens assembly is beneficial to achieve ultra-thin and compact optical imaging lens assembly.

In an exemplary embodiment, an Abbe number V1 of the first lens and an Abbe number V2 of the second lens meet: 78<V1+V2<88. Reasonable setting of the value range of the sum of the Abbe number of the first lens and the second lens is beneficial to reasonably control the dispersion of the optical system and improve the ability of correcting chromatic aberration of the optical system, thus allowing the optical system to have better imaging results.

In an exemplary embodiment, a total effective focal length f of the optical imaging lens assembly, an effective focal length f1 of the first lens, an effective focal length f6 of the sixth lens, and an effective focal length f7 of the seventh lens meet: 0.54/(f1+f607)<1.0. Reasonable setting of the ratio of the total effective focal length of the optical imaging lens assembly to the sum of the effective focal length of the first lens, the sixth lens and the seventh lens is beneficial to control the contribution of the lens to the aberration of the whole optical system and effectively balance the off-axis aberration of the system, thus improving the imaging quality of the optical system.

In an exemplary embodiment, a curvature radius R1 of the object-side surface of the first lens, a curvature radius R2 of the image-side surface of the first lens, a curvature radius R3 of an object-side surface of the second lens, and a curvature radius R4 of an image-side surface of the second lens meet: 0.3<(R1+R2)/(R3+R4)<0.8. Reasonable setting of the ratio of the sum of the curvature radius of the object-side surface and the image-side surface of the first lens to the sum of the curvature radius of the object-side surface and the image-side surface of the second lens is beneficial to realize the deflection of the optical path and balance the senior spherical aberration produced by the optical system.

In an exemplary embodiment, the effective focal length f7 of the seventh lens, a curvature radius R13 of the object-side surface of the seventh lens, and a curvature radius R14 of the image-side surface of the seventh lens meet: 0.2<f7/(R13−R14)<0.6, for example, 0.3<f7/(R13−R14)<0.5. Reasonable setting of the ratio of the effective focal length f7 of the seventh lens to the difference between the curvature radius of the object-side surface and the image-side surface of the seventh lens is beneficial to reasonably control the deflection angle of the marginal ray of the optical system, ensure the good machinability of the optical lens and reduce the sensitivity of the system.

In an exemplary embodiment, FOV is a maximum field of view of the optical imaging lens assembly, FOV meets: 82°<FOV<88°. Reasonable setting of the largest field-of-view angle is beneficial to control the imaging range of the optical system.

In an exemplary embodiment, a distance T45 between the fourth lens and the fifth lens on the optical axis, a distance T56 between the fifth lens and the sixth lens on the optical axis, a distance T67 between the sixth lens and the seventh lens on the optical axis, a center thickness CT5 of the fifth lens on the optical axis, a center thickness CT6 of the sixth lens on the optical axis, and a center thickness CT7 of the seventh lens on the optical axis meet 0.8<(T45+T56+T67)/(CT5+CT6+CT7)<1.2. Reasonable setting of the relationship between the distance between the lenses and the center thickness according to the relationship conditions above is beneficial to control the field curvature contribution of each field of view in the optical system within a reasonable range, thus balancing the field curvature generated by other lenses and effectively improving the resolution of the lens.

In an exemplary embodiment, at least one of the first lens to the seventh lens is made of glass. The use of glass lenses in the optical imaging lens assembly can have at least one of the following advantages: a wider refractive index distribution of glass, a wider selection of materials, and a lower thermal expansion coefficient of glass. Meanwhile, because of the low thermal expansion coefficient of glass, the application of glass lenses in the optical imaging system can mitigate the adverse effects caused by ambient temperature and improve the thermal stability of the optical system.

In an exemplary embodiment, the optical imaging lens assembly further includes a diaphragm. The diaphragm can be arranged at an appropriate position as required. For example, it may be arranged between the object side and the first lens. Optionally, the optical imaging lens assembly may further include an optical filter for correcting color deviation and/or protective glass for protecting a photosensitive element located on the imaging surface.

The optical imaging lens assembly according to the above embodiments of the disclosure may include a plurality of lenses such as the seven lenes above. The optical imaging lens assembly of the disclosure meets the requirements of high aperture, large imaging surface, high pixel, portability and the like, and adopts a lens structure combining glass lenses and plastic lenses to effectively improve the performance of the optical system.

In an exemplary embodiment, at least one surface of each lens is an aspheric surface, that is, at least one surface from the object-side surface of the first lens to the image-side surface of the seventh lens is an aspheric surface. The characteristic of an aspheric lens is that the curvature changes continuously from the center to the periphery of the lens. Different from the spherical lens with constant curvature from the center to the periphery of the lens, the aspheric lens has better curvature radius characteristics and advantages of improving distortion aberration and astigmatic aberration. Using the aspheric lens can eliminate the aberration during imaging as much as possible, thus improving the imaging quality. Optionally, at least one of the object-side surface and the image-side surface of each of the first lens, the second lens, the third lens, the fourth lens, the fifth lens, the sixth lens and the seventh lens is an aspheric surface. Optionally, the object-side surface and the image-side surface of each of the first lens, the second lens, the third lens, the fourth lens, the fifth lens, the sixth lens and the seventh lens are aspheric surfaces.

The disclosure also provides an imaging device. Its electronic photosensitive element may be a charge coupled device (CCD) or a complementary metal-oxide semiconductor (CMOS). The imaging device may be an independent imaging device such as a digital camera or an imaging module integrated on a mobile electronic device such as a mobile phone. The imaging device is equipped with an optical imaging lens assembly described above.

Exemplary embodiments of the disclosure also provide an electronic device including an imaging device described above.

However, it should be understood by those skilled in the art that the number of lenses constituting an optical imaging lens assembly can be changed to achieve the various results and advantages described in the Specifications, without departing from the technical scheme claimed herein. For example, although seven lenses are described in the embodiments, the optical imaging lens assembly is not limited to including seven lenses. If necessary, the optical imaging lens assembly group may further include other numbers of lenses.

Preferred embodiments of the optical imaging lens assembly applicable to the above embodiments are further described below with reference to the drawings.

### Embodiment 1

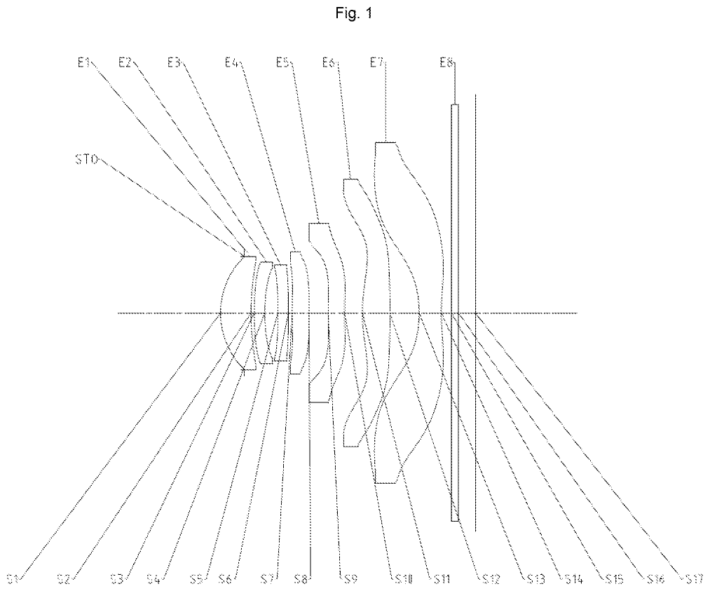

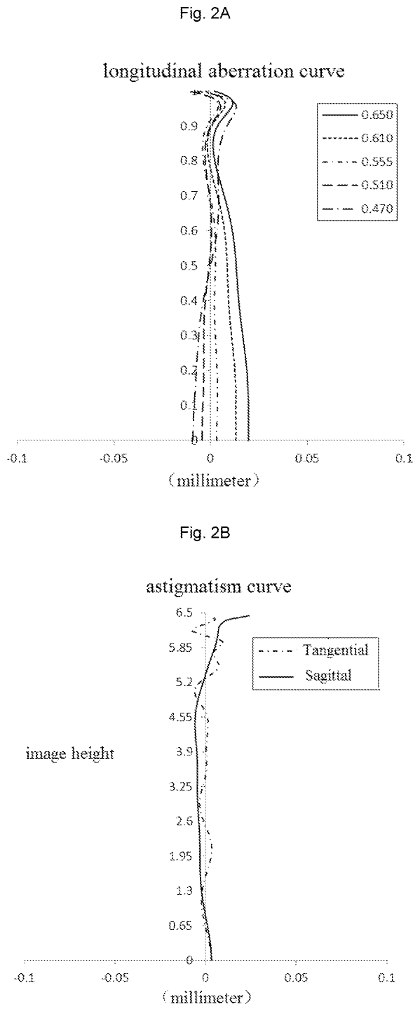

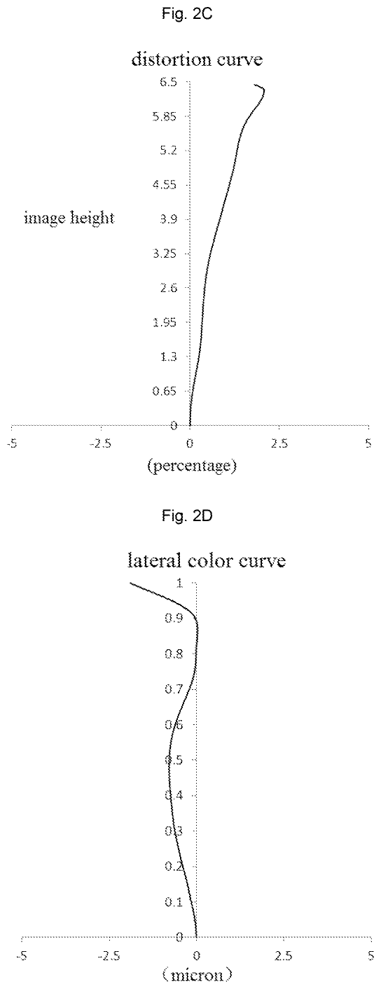

An optical imaging lens assembly according to embodiment 1 of the disclosure is described below with reference to FIG. 1 to FIG. 2D. FIG. 1 shows a structure diagram of an optical imaging lens assembly according to embodiment 1 of the disclosure.

As shown in FIG. 1, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a convex surface. The fourth lens E4 has a positive focal power, wherein an object-side surface S7 thereof is a convex surface, and an image-side surface S8 thereof is a concave surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

Table 1 shows basic parameters of the optical imaging lens assembly according to embodiment 1. The units of curvature radius, thickness/distance, and focal length are millimeters (mm).

TABLE 1

| | | | | Material | | | | |
|---|---|---|---|---|---|---|---|---|
| Surface | Surface | Curvature | Thickness/ | Refractive | Abbe | Focal | | Conic |
| number | type | radius | distance | index | number | length | Material | coefficient |
| OBJ | Spherical | Infinity | Infinity | | | | | |
| STO | Spherical | Infinity | −0.6997 | | | | | |
| S1 | Aspheric | 2.3575 | 0.8943 | 1.59 | 61.16 | 5.69 | Glass | 0.0313 |
| S2 | Aspheric | 6.7839 | 0.0962 | | | | | −1.9905 |
| S3 | Aspheric | 8.0598 | 0.3100 | 1.93 | 20.88 | −17.06 | Glass | −4.1326 |
| S4 | Aspheric | 5.2472 | 0.3855 | | | | | 5.3091 |
| S5 | Aspheric | −28.5285 | 0.3100 | 1.68 | 19.2 | −46.18 | Plastic | 99.0000 |
| S6 | Aspheric | −324.8270 | 0.1119 | | | | | 99.0000 |
| S7 | Aspheric | 15.1592 | 0.4926 | 1.55 | 56.1 | 29.34 | Plastic | −99.0000 |
| S8 | Aspheric | 279.9450 | 0.5678 | | | | | −99.0000 |
| S9 | Aspheric | 15.1960 | 0.4800 | 1.57 | 37.3 | −40.68 | Plastic | 26.8022 |
| S10 | Aspheric | 9.0768 | 0.5239 | | | | | −5.7720 |
| S11 | Aspheric | 4.7190 | 0.8130 | 1.55 | 56.1 | 6.94 | Plastic | 0.0917 |
| S12 | Aspheric | −18.0079 | 0.8580 | | | | | −99.0000 |
| S13 | Aspheric | −3.6608 | 0.6500 | 1.54 | 55.7 | −4.23 | Plastic | −1.0563 |
| S14 | Aspheric | 6.3322 | 0.2990 | | | | | −39.1219 |
| S15 | Spherical | Infinity | 0.2100 | 1.52 | 64.2 | | Glass | |
| S16 | Spherical | Infinity | 0.4978 | | | | | |
| S17 | Spherical | Infinity | | | | | | |

In this embodiment, the total effective focal length f of the optical imaging lens assembly is 6.62 mm; TTL is the distance from the object-side surface S1 of the first lens E1 to the imaging surface S17 on the optical axis, TTL is 7.50 mm; ImgH is a half of the diagonal length of the effective pixel region on the imaging surface S17, ImgH is 6.45 mm; and FOV is a maximum field of view of the optical imaging lens assembly, FOV is 87.5°.

In embodiment 1, an object-side surface and an image-side surface of any one of the first lens E1 to the seventh lens E7 are aspheric surfaces, and the surface type x of each aspheric lens can be defined by but not limited to the following aspheric surface formula:

$$x = \frac{{ch}^{2}}{1 + \sqrt{1 - ( k + 1 ) {c}^{2} {h}^{2}}} + \sum {Aih}^{i} \qquad ( 1 )$$

Where, x is a vector height from the vertex of the aspheric surface to the aspheric surface at the position of height h along the optical axis; c is a paraxial curvature of the aspheric surface, c=1/R (i.e. the paraxial curvature cis the reciprocal of the curvature radius R in Table 1 above); K is a conic coefficient; Ai is a modified coefficient of the i-th order of the aspheric surface. Table 2 below provides higher-order coefficients A₄, A₆, A₈, A₁₀, A₁₂, A₁₄, A₁₆, A₁₈, and A₂₀ that may be used for aspheric lens surfaces S1-S14 in embodiment 1.

TABLE 2

| Surface | | | | | |
|---|---|---|---|---|---|
| number | A4 | A6 | A8 | A10 | A12 |
| S1 | 4.0700E−05 | 2.7260E−03 | −4.9400E−03 | 6.1350E−03 | −4.9500E−03 |
| S2 | −1.4250E−02 | 4.0980E−03 | 6.0740E−03 | −1.1190E−02 | 1.0616E−02 |
| S3 | −8.5400E−03 | 8.3400E−03 | 6.6060E−03 | −1.4630E−02 | 1.4719E−02 |
| S4 | −4.8000E−04 | 8.5660E−03 | −3.1200E−03 | 3.2540E−03 | −6.0700E−03 |
| S5 | −1.5550E−02 | 1.9270E−03 | −4.0300E−03 | −5.6500E−03 | 1.7337E−02 |
| S6 | −2.8530E−02 | 1.9569E−02 | −2.2640E−02 | 1.1455E−02 | 7.1300E−03 |
| S7 | −3.5690E−02 | 1.9959E−02 | −1.9480E−02 | 4.2260E−03 | 1.0434E−02 |
| S8 | −3.0900E−02 | 1.4311E−02 | −2.1040E−02 | 2.0594E−02 | −1.5480E−02 |
| S9 | −5.2890E−02 | 1.0165E−02 | 4.1990E−03 | −8.1600E−03 | 4.4240E−03 |
| S10 | −6.3400E−02 | 1.5429E−02 | −1.4000E−03 | −1.1900E−03 | 5.6100E−04 |
| S11 | −1.5780E−02 | −5.5200E−03 | 2.9910E−03 | −9.4000E−04 | 1.6900E−04 |
| S12 | 1.7041E−02 | −1.1480E−02 | 3.6200E−03 | −7.8000E−04 | 1.0900E−04 |
| S13 | −2.4520E−02 | 3.0030E−03 | 6.0100E−04 | −1.6000E−04 | 1.6200E−05 |
| S14 | −2.0660E−02 | 3.4120E−03 | −3.8000E−04 | 2.7000E−05 | −1.2000E−06 |

| Surface | | | | |
|---|---|---|---|---|
| number | A14 | A16 | A18 | A20 |
| S1 | 2.5750E−03 | −8.4000E−04 | 1.5400E−04 | −1.2000E−05 |
| S2 | −6.3500E−03 | 2.3140E−03 | −4.6000E−04 | 3.8600E−05 |
| S3 | −9.1200E−03 | 3.5400E−03 | −7.8000E−04 | 7.3900E−05 |
| S4 | 6.4060E−03 | −3.5800E−03 | 1.0430E−03 | −1.2000E−04 |
| S5 | −1.9210E−02 | 1.1088E−02 | −3.2600E−03 | 3.7700E−04 |
| S6 | −1.4140E−02 | 9.1350E−03 | −2.7500E−03 | 3.2300E−04 |
| S7 | −1.2060E−02 | 6.0970E−03 | −1.5000E−03 | 1.4500E−04 |
| S8 | 8.0030E−03 | −2.6100E−03 | 4.8200E−04 | −3.8000E−05 |
| S9 | −1.2400E−03 | 1.6900E−04 | −6.4000E−06 | −4.3000E−07 |
| S10 | −9.8000E−05 | 7.3300E−06 | −1.2000E−07 | −7.0000E−09 |
| S11 | −1.7000E−05 | 1.0400E−06 | −3.3000E−08 | 4.3900E−10 |
| S12 | −9.6000E−06 | 5.1200E−07 | −1.5000E−08 | 1.8600E−10 |
| S13 | −9.1000E−07 | 3.0100E−08 | −5.5000E−10 | 4.3200E−12 |
| S14 | 2.0400E−08 | 4.6100E−10 | −2.7000E−11 | 3.3000E−13 |

FIG. 2A shows a longitudinal aberration curve of the optical imaging lens assembly according to embodiment 1. The curve shows common focus-point migration after light rays of different wavelengths pass through the lens. FIG. 2B shows an astigmatic curve of the optical imaging lens assembly according to embodiment 1. The curve shows curvature of meridianal image surface and curvature of sagittal image surface. FIG. 2C shows a distortion curve of the optical imaging lens assembly according to embodiment 1. The curve shows distortion values corresponding to different image heights. FIG. 2D shows a lateral color curve of the optical imaging lens assembly according to embodiment 1. The curve shows the deviation of different image heights on the imaging surface after the light rays pass through the lens. As we can see from FIGS. 2A to 2D, the optical imaging lens assembly according to embodiment 1 can achieve good imaging quality.

### Embodiment 2

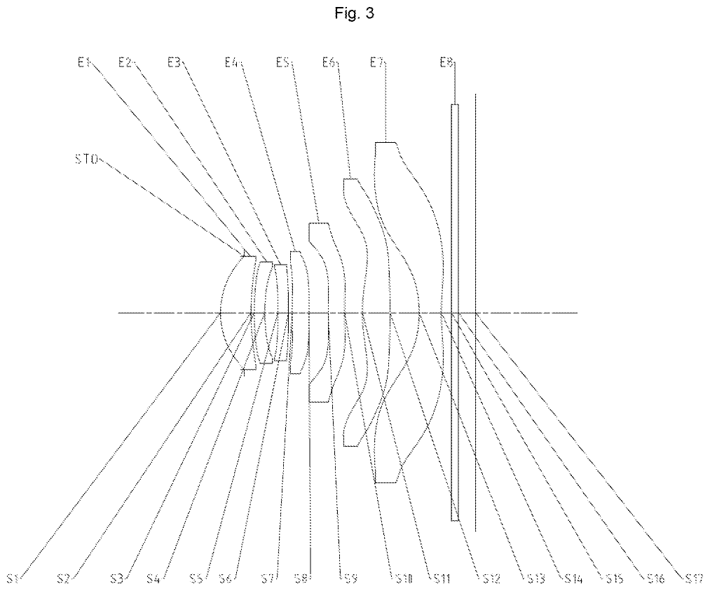

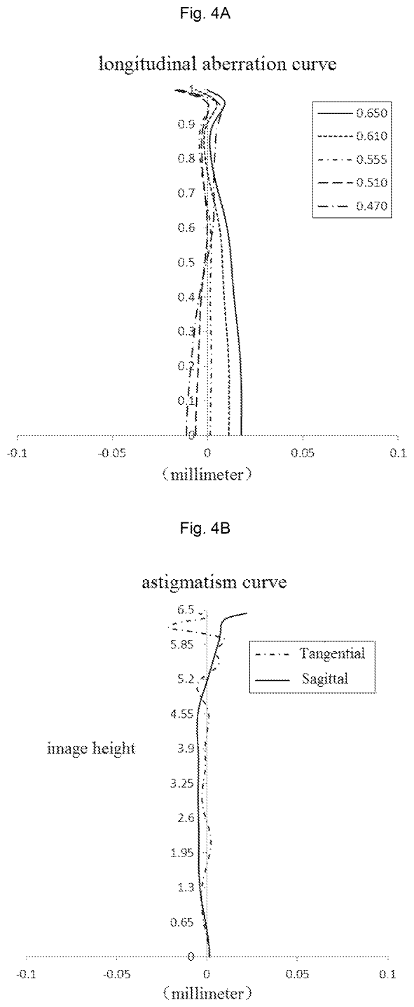

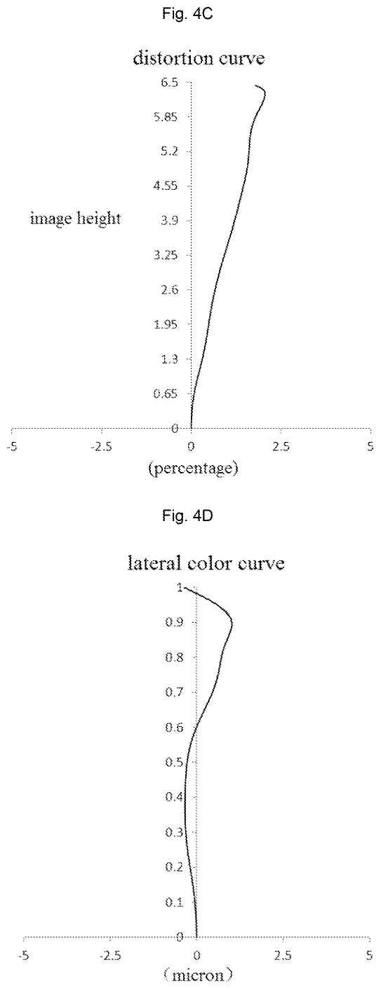

An optical imaging lens assembly according to embodiment 2 of the disclosure is described below with reference to FIG. 3 to FIG. 4D. FIG. 3 shows a structure diagram of an optical imaging lens assembly according to embodiment 2 of the disclosure.

As shown in FIG. 3, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a concave surface. The fourth lens E4 has a positive focal power, wherein an object-side surface S7 thereof is a convex surface, and an image-side surface S8 thereof is a concave surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.62 mm; TTL is the distance from the object-side surface S1 of the first lens E1 to the imaging surface S17 on the optical axis, TTL is 7. S1 mm; ImgH is a half of the diagonal length of the effective pixel region on the imaging surface S17, ImgH is 6.44 mm; and FOV is a maximum field of view of the optical imaging lens assembly, FOV is 87.5°.

Table 3 shows basic parameters of the optical imaging lens assembly according to embodiment 2. The units of curvature radius, thickness/distance, and focal length are millimeters (mm).

TABLE 3

| | | | | Material | | | | |
|---|---|---|---|---|---|---|---|---|
| Surface | Surface | Curvature | Thickness/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6875 | | | | | |
| S1 | Aspheric | 2.3606 | 0.8958 | 1.59 | 61.16 | 5.66 | Glass | 0.0040 |
| S2 | Aspheric | 6.9070 | 0.1137 | | | | | −3.4431 |
| S3 | Aspheric | 8.8673 | 0.3100 | 1.93 | 20.88 | −15.85 | Glass | −2.2577 |
| S4 | Aspheric | 5.4456 | 0.3819 | | | | | 6.4356 |
| S5 | Aspheric | −38.4653 | 0.3100 | 1.67 | 20.4 | −53.70 | Plastic | 30.2169 |
| S6 | Aspheric | 507.7131 | 0.1182 | | | | | −99.0000 |
| S7 | Aspheric | 15.1472 | 0.5030 | 1.55 | 56.1 | 29.32 | Plastic | −99.0000 |
| S8 | Aspheric | 279.4465 | 0.5757 | | | | | −99.0000 |
| S9 | Aspheric | 12.3896 | 0.4800 | 1.57 | 37.3 | −42.37 | Plastic | 19.0625 |
| S10 | Aspheric | 8.0754 | 0.5168 | | | | | −5.7179 |
| S11 | Aspheric | 4.7891 | 0.8121 | 1.55 | 56.1 | 6.89 | Plastic | 0.1015 |
| S12 | Aspheric | −16.4962 | 0.8314 | | | | | −96.9830 |
| S13 | Aspheric | −3.7562 | 0.6500 | 1.54 | 55.7 | −4.20 | Plastic | −1.0178 |
| S14 | Aspheric | 5.9714 | 0.3028 | | | | | −37.0095 |
| S15 | Spherical | Infinite | 0.2100 | 1.52 | 64.2 | | Glass | |
| S16 | Spherical | Infinite | 0.5017 | | | | | |
| S17 | Spherical | Infinite | | | | | | |

In embodiment 2, an object-side surface and an image-side surface of any one of the first lens E1 to the seventh lens E7 are aspheric surfaces. Table 4 below provides higher-order coefficients A₄, A₆, A₈, A₁₀, A₁₂, A₁₄, A₁₆, A₁₈, and A₂₀ that may be used for aspheric lens surfaces S1-S14 in embodiment 2.

TABLE 4

| Surface | | | | | |
|---|---|---|---|---|---|
| number | A4 | A6 | A8 | A10 | A12 |
| S1 | 2.4100E−04 | 2.3820E−03 | −4.4000E−03 | 5.4390E−03 | −4.3800E−03 |
| S2 | −1.3380E−02 | 3.0660E−03 | 6.4130E−03 | −1.1790E−02 | 1.1449E−02 |
| S3 | −8.3100E−03 | 8.0320E−03 | 9.6410E−03 | −2.1070E−02 | 2.2327E−02 |
| S4 | −6.8000E−05 | 1.0638E−02 | −6.8400E−03 | 1.4601E−02 | −2.5750E−02 |
| S5 | −1.7720E−02 | 7.3840E−03 | −1.8340E−02 | 2.4254E−02 | −2.4060E−02 |
| S6 | −3.0660E−02 | 2.1357E−02 | −2.5630E−02 | 1.5738E−02 | 1.4410E−03 |
| S7 | −3.5360E−02 | 1.6769E−02 | −1.1660E−02 | −7.7700E−03 | 2.1449E−02 |
| S8 | −3.0280E−02 | 1.2834E−02 | −1.8070E−02 | 1.6735E−02 | −1.2090E−02 |
| S9 | −5.2180E−02 | 1.2559E−02 | 5.3700E−04 | −4.9300E−03 | 2.8940E−03 |
| S10 | −6.2290E−02 | 1.6347E−02 | −2.3800E−03 | −6.8000E−04 | 4.3700E−04 |
| S11 | −1.5930E−02 | −5.1600E−03 | 2.7780E−03 | −8.8000E−04 | 1.6200E−04 |
| S12 | 1.6241E−02 | −1.0900E−02 | 3.4000E−03 | −7.2000E−04 | 1.0200E−04 |
| S13 | −2.5010E−02 | 3.0710E−03 | 6.2100E−04 | −1.7000E−04 | 1.7000E−05 |
| S14 | −1.9450E−02 | 3.0200E−03 | −2.9000E−04 | 1.2500E−05 | 1.9300E−07 |

| Surface | | | | |
|---|---|---|---|---|
| number | A14 | A16 | A18 | A20 |
| S1 | 2.2660E−03 | −7.3000E−04 | 1.3300E−04 | −1.1000E−05 |
| S2 | −7.0100E−03 | 2.6050E−03 | −5.3000E−04 | 4.5200E−05 |
| S3 | −1.4530E−02 | 5.8130E−03 | −1.2900E−03 | 1.2200E−04 |
| S4 | 2.6445E−02 | −1.5500E−02 | 4.9010E−03 | −6.5000E−04 |
| S5 | 1.7357E−02 | −8.7700E−03 | 2.7860E−03 | −4.1000E−04 |
| S6 | −9.1700E−03 | 6.3910E−03 | −1.8900E−03 | 2.1000E−04 |
| S7 | −1.8380E−02 | 8.2240E−03 | −1.8700E−03 | 1.7000E−04 |
| S8 | 6.0470E−03 | −1.9100E−03 | 3.4300E−04 | −2.6000E−05 |
| S9 | −8.4000E−04 | 1.2400E−04 | −7.1000E−06 | −2.4000E−08 |
| S10 | −9.1000E−05 | 9.1500E−06 | −4.4000E−07 | 7.9200E−09 |
| S11 | −1.7000E−05 | 1.0300E−06 | −3.3000E−08 | 4.4700E−10 |
| S12 | −9.1000E−06 | 4.8700E−07 | −1.4000E−08 | 1.8300E−10 |
| S13 | −9.7000E−07 | 3.2200E−08 | −5.9000E−10 | 4.7000E−12 |
| S14 | −5.5000E−08 | 2.9900E−09 | −7.3000E−11 | 6.8100E−13 |

FIG. 4A shows a longitudinal aberration curve of the optical imaging lens assembly according to embodiment 2. The curve shows common focus-point migration after light rays of different wavelengths pass through the lens. FIG. 4B shows an astigmatic curve of the optical imaging lens assembly according to embodiment 2. The curve shows curvature of meridianal image surface and curvature of sagittal image surface. FIG. 4C shows a distortion curve of the optical imaging lens assembly according to embodiment 2. The curve shows distortion values corresponding to different image heights. FIG. 4D shows a lateral color curve of the optical imaging lens assembly according to embodiment 2. The curve shows the deviation of different image heights on the imaging surface after the light rays pass through the lens. As we can see from FIGS. 4A to 4D, the optical imaging lens assembly according to embodiment 2 can achieve good imaging quality.

### Embodiment 3

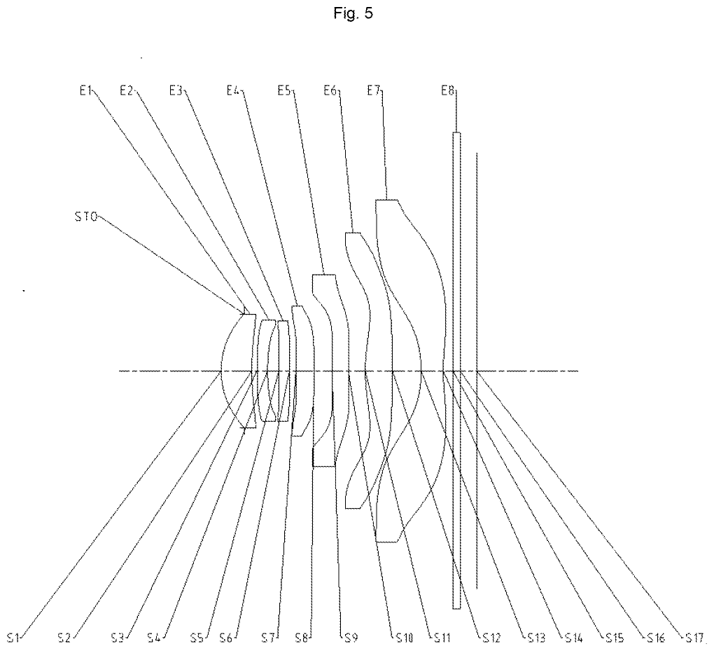

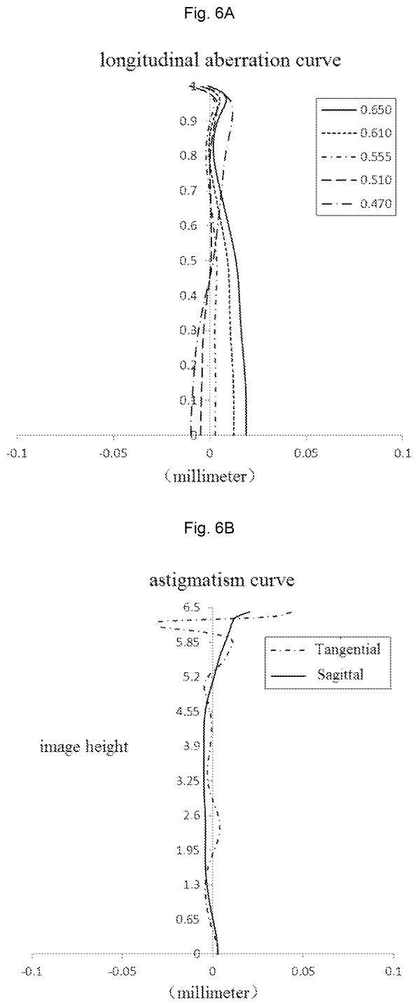

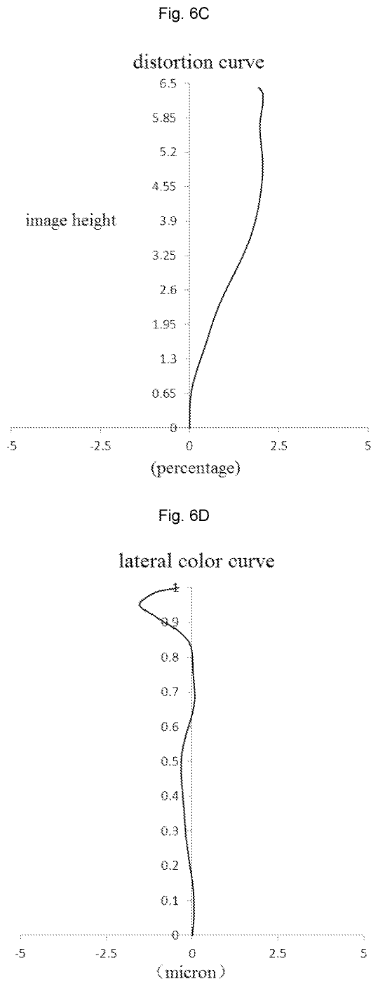

An optical imaging lens assembly according to embodiment 3 of the disclosure is described below with reference to FIG. 5 to FIG. 6D. FIG. 5 shows a structure diagram of an optical imaging lens assembly according to embodiment 3 of the disclosure.

As shown in FIG. 5, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a positive focal power, wherein an object-side surface S5 thereof is a convex surface, and an image-side surface S6 thereof is a concave surface. The fourth lens E4 has a positive focal power, wherein an object-side surface S7 thereof is a convex surface, and an image-side surface S8 thereof is a convex surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.62 mm; TTL is the distance from the object-side surface S1 of the first lens E1 to the imaging surface S17 on the optical axis, TTL is 7. S2 mm; ImgH is a half of the diagonal length of the effective pixel region on the imaging surface S17, ImgH is 6.42 mm; and FOV is a maximum field of view of the optical imaging lens assembly, FOV is 87.2°.

Table 5 shows basic parameters of the optical imaging lens assembly according to embodiment 3. The units of curvature radius, thickness/distance, and focal length are millimeters (mm).

TABLE 5

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6736 | | | | | |
| S1 | Aspheric | 2.3595 | 0.9037 | 1.59 | 61.16 | 5.44 | Glass | −0.0329 |
| S2 | Aspheric | 7.6125 | 0.1554 | | | | | −3.6493 |
| S3 | Aspheric | 13.0287 | 0.3100 | 1.93 | 20.88 | −12.31 | Glass | 11.9825 |
| S4 | Aspheric | 6.0265 | 0.3345 | | | | | 9.3704 |
| S5 | Aspheric | 31.9981 | 0.3100 | 1.67 | 20.4 | 589.50 | Plastic | 98.0776 |
| S6 | Aspheric | 34.7038 | 0.1896 | | | | | −12.0032 |
| S7 | Aspheric | 25.8685 | 0.5335 | 1.55 | 56.1 | 43.19 | Plastic | −70.1320 |
| S8 | Aspheric | −264.5240 | 0.5270 | | | | | 99.0000 |
| S9 | Aspheric | 10.7551 | 0.4800 | 1.57 | 37.3 | −45.84 | Plastic | 15.5392 |
| S10 | Aspheric | 7.4970 | 0.5012 | | | | | −4.5820 |
| S11 | Aspheric | 4.9921 | 0.8041 | 1.55 | 56.1 | 7.01 | Plastic | 0.1527 |
| S12 | Aspheric | −15.4697 | 0.8405 | | | | | −77.4648 |
| S13 | Aspheric | −3.9094 | 0.6500 | 1.54 | 55.7 | −4.13 | Plastic | −0.9633 |
| S14 | Aspheric | 5.4059 | 0.2858 | | | | | −35.0075 |
| S15 | Spherical | Infinite | 0.2100 | 1.52 | 64.2 | | Glass | |
| S16 | Spherical | Infinite | 0.4846 | | | | | |
| S17 | Spherical | Infinite | | | | | | |

In embodiment 3, an object-side surface and an image-side surface of any one of the first lens E1 to the seventh lens E7 are aspheric surfaces. Table 6 below provides higher-order coefficients A₄, A₆, A₈, A₁₀, A₁₂, A₁₄, A₁₆, A₁₈, and A₂₀ that may be used for aspheric lens surfaces S1-S14 in embodiment 3.

TABLE 6

| Surface | | | | | |
|---|---|---|---|---|---|
| number | A4 | A6 | A8 | A10 | A12 |
| S1 | 4.6900E−04 | 1.7690E−03 | −3.8000E−03 | 5.1000E−03 | −4.3900E−03 |
| S2 | −1.1250E−02 | 2.6340E−03 | 4.8680E−03 | −1.0880E−02 | 1.1560E−02 |
| S3 | −5.5300E−03 | 1.1856E−02 | 1.6700E−03 | −1.0800E−02 | 1.2750E−02 |
| S4 | 2.6560E−03 | 1.0806E−02 | 8.7900E−03 | −3.1670E−02 | 4.7711E−02 |
| S5 | −2.1030E−02 | 1.7450E−03 | 1.6062E−02 | −5.5040E−02 | 8.6595E−02 |
| S6 | −2.6140E−02 | 7.0530E−03 | −1.0000E−04 | −1.3040E−02 | 2.0207E−02 |
| S7 | −2.5780E−02 | −3.2400E−03 | 2.1864E−02 | −4.5530E−02 | 4.8405E−02 |
| S8 | −2.8600E−02 | 1.1406E−02 | −1.5960E−02 | 1.4476E−02 | −1.0120E−02 |
| S9 | −5.1490E−02 | 1.5966E−02 | −4.5500E−03 | −4.2000E−04 | 5.4900E−04 |
| S10 | −5.9620E−02 | 1.6241E−02 | −2.6200E−03 | −4.7000E−04 | 3.7000E−04 |
| S11 | −1.4880E−02 | −5.4900E−03 | 2.8310E−03 | −8.7000E−04 | 1.5700E−04 |
| S12 | 1.6994E−02 | −1.0950E−02 | 3.3250E−03 | −6.8000E−04 | 9.1900E−05 |
| S13 | −2.4480E−02 | 2.9580E−03 | 5.8200E−04 | −1.5000E−04 | 1.5500E−05 |
| S14 | −1.6720E−02 | 2.1840E−03 | −1.1000E−04 | −1.0000E−05 | 2.0000E−06 |

| Surface | | | | |
|---|---|---|---|---|
| number | A14 | A16 | A18 | A20 |
| S1 | 2.3530E−03 | −7.8000E−04 | 1.4100E−04 | −1.1126E−05 |
| S2 | −7.4400E−03 | 2.8400E−03 | −5.9000E−04 | 5.0541E−05 |
| S3 | −8.5800E−03 | 3.5110E−03 | −7.9000E−04 | 7.4255E−05 |
| S4 | −4.2780E−02 | 2.3174E−02 | −6.9100E−03 | 8.7633E−04 |
| S5 | −7.9120E−02 | 4.2589E−02 | −1.2480E−02 | 1.5462E−03 |
| S6 | −1.5380E−02 | 6.5410E−03 | −1.4100E−03 | 1.1705E−04 |
| S7 | −3.0110E−02 | 1.0973E−02 | −2.1300E−03 | 1.6945E−04 |
| S8 | 4.8090E−03 | −1.4300E−03 | 2.3900E−04 | −1.6729E−05 |
| S9 | −1.1000E−04 | −5.3000E−06 | 4.4700E−06 | −3.9279E−07 |
| S10 | −8.4000E−05 | 9.5900E−06 | −5.6000E−07 | 1.3630E−08 |
| S11 | −1.6000E−05 | 9.8100E−07 | −3.2000E−08 | 4.2420E−10 |
| S12 | −7.9000E−06 | 4.1700E−07 | −1.2000E−08 | 1.5040E−10 |
| S13 | −8.6000E−07 | 2.8100E−08 | −5.0000E−10 | 3.8188E−12 |
| S14 | −1.4000E−07 | 5.3600E−09 | −1.0000E−10 | 8.2729E−13 |

FIG. 6A shows a longitudinal aberration curve of the optical imaging lens assembly according to embodiment 3. The curve shows common focus-point migration after light rays of different wavelengths pass through the lens. FIG. 6B shows an astigmatic curve of the optical imaging lens assembly according to embodiment 3. The curve shows curvature of meridianal image surface and curvature of sagittal image surface. FIG. 6C shows a distortion curve of the optical imaging lens assembly according to embodiment 3. The curve shows distortion values corresponding to different image heights. FIG. 6D shows a lateral color curve of the optical imaging lens assembly according to embodiment 3. The curve shows the deviation of different image heights on the imaging surface after the light rays pass through the lens. As we can see from FIGS. 6A to 6D, the optical imaging lens assembly according to embodiment 3 can achieve good imaging quality.

### Embodiment 4

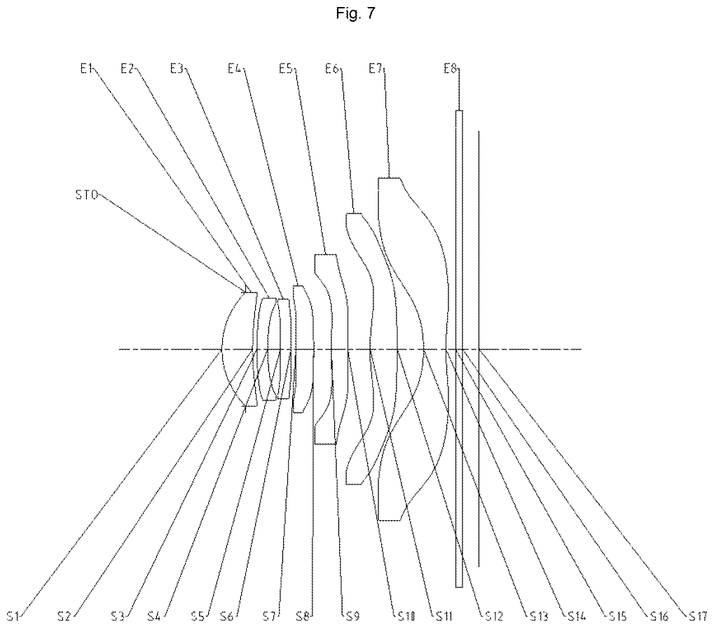

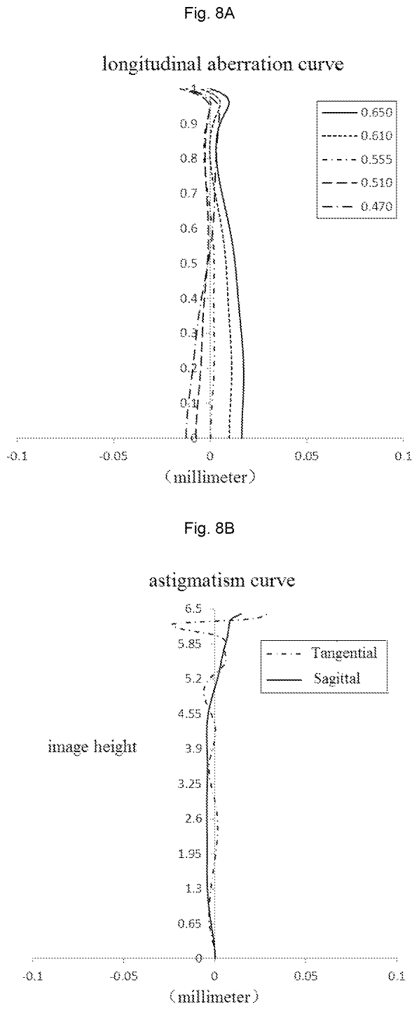

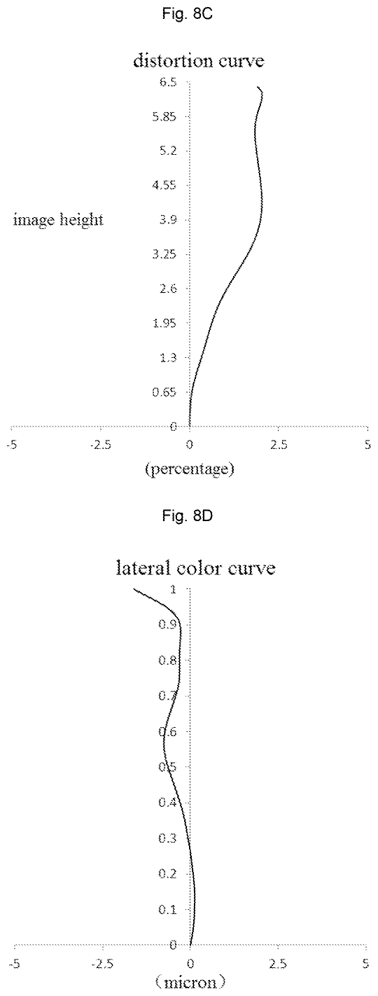

An optical imaging lens assembly according to embodiment 4 of the disclosure is described below with reference to FIG. 7 to FIG. 8D. FIG. 7 shows a structure diagram of an optical imaging lens assembly according to embodiment 4 of the disclosure.

As shown in FIG. 7, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a concave surface. The fourth lens E4 has a positive focal power, wherein an object-side surface S7 thereof is a convex surface, and an image-side surface S8 thereof is a concave surface. The fifth lens E5 has a positive focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.62 mm; TTL is the distance from the object-side surface S1 of the first lens E1 to the imaging surface S17 on the optical axis, TTL is 7.53 mm; ImgH is a half of the diagonal length of the effective pixel region on the imaging surface S17, ImgH is 6.41 mm; and FOV is a maximum field of view of the optical imaging lens assembly, FOV is 87.1°.

Table 7 shows basic parameters of the optical imaging lens assembly according to embodiment 4. The units of curvature radius, thickness/distance, and focal length are millimeters (mm).

TABLE 7

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6809 | | | | | |
| S1 | Aspheric | 2.3645 | 0.8941 | 1.59 | 61.16 | 5.58 | Glass | −0.0094 |
| S2 | Aspheric | 7.1849 | 0.1326 | | | | | −2.6314 |
| S3 | Aspheric | 10.9722 | 0.3100 | 1.93 | 20.88 | −14.34 | Glass | 7.0158 |
| S4 | Aspheric | 5.9389 | 0.3763 | | | | | 8.3371 |
| S5 | Aspheric | −106.7480 | 0.3100 | 1.67 | 20.4 | −70.93 | Plastic | 99.0000 |
| S6 | Aspheric | 84.7787 | 0.1403 | | | | | −99.0000 |
| S7 | Aspheric | 17.9024 | 0.5191 | 1.55 | 56.1 | 33.97 | Plastic | −85.9892 |
| S8 | Aspheric | 512.0077 | 0.5160 | | | | | 99.0000 |
| S9 | Aspheric | 9.5017 | 0.4800 | 1.57 | 37.3 | 303.03 | Plastic | 14.0751 |
| S10 | Aspheric | 9.8699 | 0.6576 | | | | | 1.1786 |
| S11 | Aspheric | 5.8798 | 0.7950 | 1.55 | 56.1 | 8.17 | Plastic | 0.4150 |
| S12 | Aspheric | −17.5567 | 0.7698 | | | | | −34.6656 |
| S13 | Aspheric | −3.8771 | 0.6500 | 1.54 | 55.7 | −4.14 | Plastic | −0.9641 |
| S14 | Aspheric | 5.5061 | 0.2852 | | | | | −33.5588 |
| S15 | Spherical | Infinite | 0.2100 | 1.52 | 64.2 | | Glass | |
| S16 | Spherical | Infinite | 0.4840 | | | | | |
| S17 | Spherical | Infinite | | | | | | |

In embodiment 4, an object-side surface and an image-side surface of any one of the first lens E1 to the seventh lens E7 are aspheric surfaces. Table 8 below provides higher-order coefficients A₄, A₆, A₈, A₁₀, A₁₂, A₁₄, A₁₆, A₁₈, and A₂₀ that may be used for aspheric lens surfaces S1-S14 in embodiment 4.

TABLE 8

| Surface | | | | | |
|---|---|---|---|---|---|
| number | A4 | A6 | A8 | A10 | A12 |
| S1 | 3.6600E−04 | 2.1440E−03 | −4.4500E−03 | 5.9360E−03 | −5.0752E−03 |
| S2 | −1.1480E−02 | 2.6370E−03 | 4.7790E−03 | −9.5900E−03 | 9.8036E−03 |
| S3 | −5.0300E−03 | 8.8680E−03 | 6.3240E−03 | −1.6830E−02 | 1.8842E−02 |
| S4 | 3.3100E−03 | 1.0397E−02 | −1.2800E−03 | −1.6100E−03 | 6.8646E−05 |
| S5 | −2.2480E−02 | 9.2870E−03 | −1.9220E−02 | 2.3989E−02 | −2.1648E−02 |
| S6 | −3.3000E−02 | 1.8499E−02 | −2.1690E−02 | 1.3852E−02 | −1.0741E−03 |
| S7 | −3.3980E−02 | 1.3357E−02 | −6.7600E−03 | −1.0930E−02 | 2.0938E−02 |
| S8 | −3.1520E−02 | 1.2056E−02 | −1.4200E−02 | 1.1278E−02 | −7.3559E−03 |
| S9 | −4.5510E−02 | 1.0397E−02 | −2.2200E−03 | −7.2000E−04 | 4.3403E−04 |
| S10 | −4.5290E−02 | 8.8000E−03 | 7.1100E−05 | −1.1100E−03 | 4.7165E−04 |
| S11 | −1.0830E−02 | −6.1700E−03 | 2.5250E−03 | −7.1000E−04 | 1.2621E−04 |
| S12 | 1.4286E−02 | −1.0340E−02 | 2.8540E−03 | −5.2000E−04 | 6.5758E−05 |
| S13 | −2.4820E−02 | 2.9630E−03 | 5.9900E−04 | −1.6000E−04 | 1.6155E−05 |
| S14 | −1.7390E−02 | 2.3600E−03 | −9.4000E−05 | −1.9000E−05 | 3.0836E−06 |

| Surface | | | | |
|---|---|---|---|---|
| number | A14 | A16 | A18 | A20 |
| S1 | 2.7330E−03 | −9.1000E−04 | 1.6700E−04 | −1.3000E−05 |
| S2 | −6.2200E−03 | 2.3640E−03 | −4.9000E−04 | 4.2100E−05 |
| S3 | −1.2620E−02 | 5.1380E−03 | −1.1500E−03 | 1.0900E−04 |
| S4 | 2.3040E−03 | −2.1600E−03 | 8.8100E−04 | −1.4000E−04 |
| S5 | 1.3561E−02 | −5.7500E−03 | 1.5740E−03 | −2.1000E−04 |
| S6 | −4.8100E−03 | 3.5390E−03 | −1.0000E−03 | 1.0100E−04 |
| S7 | −1.6260E−02 | 6.8240E−03 | −1.4700E−03 | 1.2700E−04 |
| S8 | 3.4130E−03 | −1.0100E−03 | 1.7100E−04 | −1.2000E−05 |
| S9 | −6.1000E−05 | −1.1000E−05 | 4.0900E−06 | −3.3000E−07 |
| S10 | −9.6000E−05 | 1.0700E−05 | −6.3000E−07 | 1.5400E−08 |
| S11 | −1.3000E−05 | 8.0300E−07 | −2.6000E−08 | 3.5900E−10 |
| S12 | −5.6000E−06 | 2.9200E−07 | −8.6000E−09 | 1.0900E−10 |
| S13 | −9.1000E−07 | 3.0500E−08 | −5.6000E−10 | 4.4900E−12 |
| S14 | −2.2000E−07 | 8.5200E−09 | −1.8000E−10 | 1.4800E−12 |

FIG. 8A shows a longitudinal aberration curve of the optical imaging lens assembly according to embodiment 4. The curve shows common focus-point migration after light rays of different wavelengths pass through the lens. FIG. 8B shows an astigmatic curve of the optical imaging lens assembly according to embodiment 4. The curve shows curvature of meridianal image surface and curvature of sagittal image surface. FIG. 8C shows a distortion curve of the optical imaging lens assembly according to embodiment 4. The curve shows distortion values corresponding to different image heights. FIG. 8D shows a lateral color curve of the optical imaging lens assembly according to embodiment 4. The curve shows the deviation of different image heights on the imaging surface after the light rays pass through the lens. As we can see from FIGS. 8A to 8D, the optical imaging lens assembly according to embodiment 4 can achieve good imaging quality.

### Embodiment 5

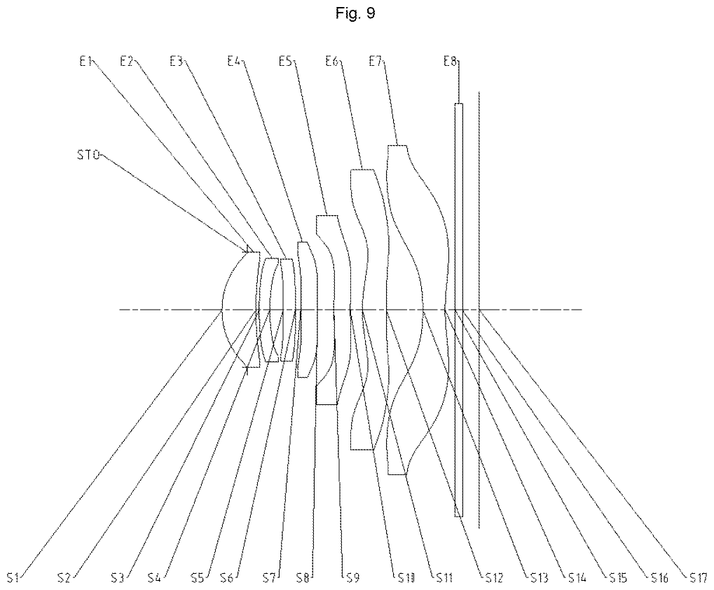

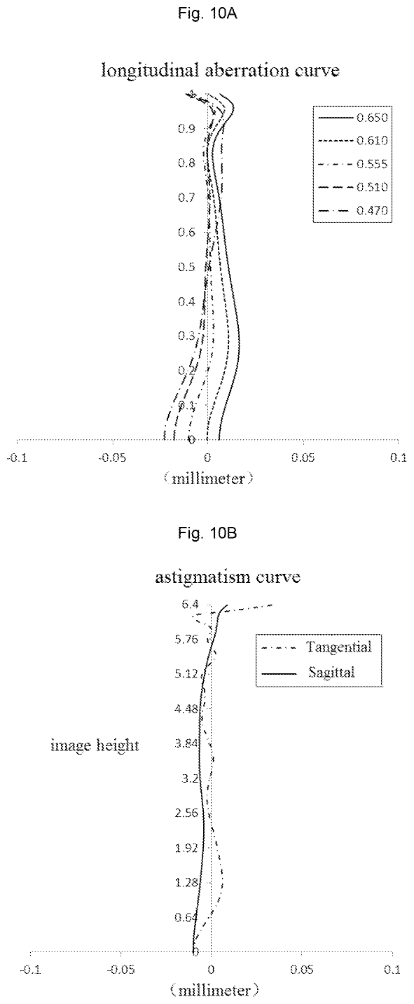

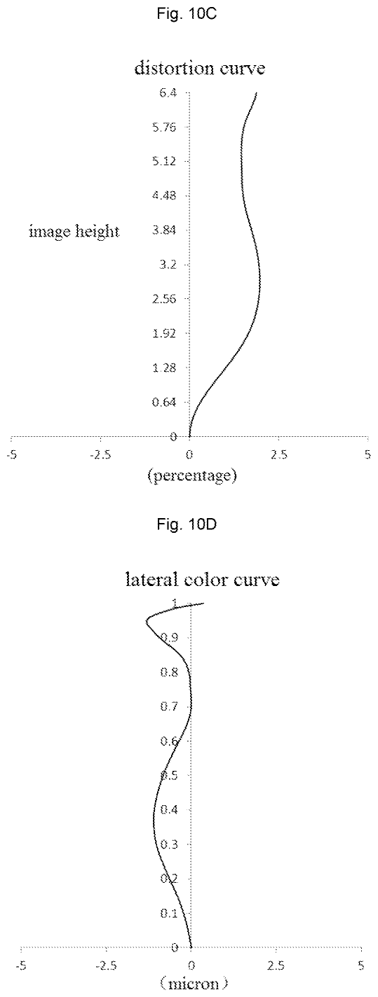

An optical imaging lens assembly according to embodiment 5 of the disclosure is described below with reference to FIG. 9 to FIG. 10D. FIG. 9 shows a structure diagram of an optical imaging lens assembly according to embodiment 5 of the disclosure.

As shown in FIG. 9, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a convex surface. The fourth lens E4 has a positive focal power, wherein an object-side surface S7 thereof is a convex surface, and an image-side surface S8 thereof is a concave surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a concave surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.68 mm; TTL is the distance from the object-side surface S1 of the first lens E1 to the imaging surface S17 on the optical axis, TTL is 7.53 mm; ImgH is a half of the diagonal length of the effective pixel region on the imaging surface S17, ImgH is 6.40 mm; and FOV is a maximum field of view of the optical imaging lens assembly, FOV is 86.3°.

Table 9 shows basic parameters of the optical imaging lens assembly according to embodiment 5. The units of curvature radius, thickness/distance, and focal length are millimeters (mm).

TABLE 9

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.7377 | | | | | |
| S1 | Aspheric | 2.2317 | 0.9902 | 1.51 | 60.46 | 5.72 | Glass | −0.0133 |
| S2 | Aspheric | 7.9450 | 0.0982 | | | | | −1.4835 |
| S3 | Aspheric | 8.2264 | 0.3100 | 1.96 | 17.94 | −15.78 | Glass | −1.3652 |
| S4 | Aspheric | 5.2243 | 0.3936 | | | | | 6.1090 |
| S5 | Aspheric | −114.3040 | 0.3552 | 1.68 | 19.2 | −372.40 | Plastic | 8.5541 |
| S6 | Aspheric | −209.2270 | 0.1551 | | | | | 99.0000 |
| S7 | Aspheric | 18.8602 | 0.4951 | 1.55 | 56.1 | 73.38 | Plastic | −65.0903 |
| S8 | Aspheric | 35.3088 | 0.4768 | | | | | −37.7269 |
| S9 | Aspheric | 10.6767 | 0.4800 | 1.57 | 37.3 | −35.94 | Plastic | 16.5685 |
| S10 | Aspheric | 6.9056 | 0.3540 | | | | | −7.5931 |
| S11 | Aspheric | 4.0555 | 0.6996 | 1.55 | 56.1 | 8.07 | Plastic | 0.0008 |
| S12 | Aspheric | 47.6191 | 1.0701 | | | | | 99.0000 |
| S13 | Aspheric | −5.6605 | 0.6500 | 1.54 | 55.7 | −4.94 | Plastic | −0.4855 |
| S14 | Aspheric | 5.1892 | 0.2966 | | | | | −15.2357 |
| S15 | Spherical | Infinite | 0.2100 | 1.52 | 64.2 | | Glass | |
| S16 | Spherical | Infinite | 0.4955 | | | | | |
| S17 | Spherical | Infinite | | | | | | |

In embodiment 5, an object-side surface and an image-side surface of any one of the first lens E1 to the seventh lens E7 are aspheric surfaces. Table 10 below provides higher-order coefficients A₄, A₆, A₈, A₁₀, A₁₂, A₁₄, A₁₆, A₁₈, and A₂₀ that may be used for aspheric lens surfaces S1-S14 in embodiment 5.

TABLE 10

| Surface | | | | | |
|---|---|---|---|---|---|
| number | A4 | A6 | A8 | A10 | A12 |
| S1 | −6.7000E−05 | 2.7140E−03 | −5.6465E−03 | 7.8040E−03 | −6.9000E−03 |
| S2 | −1.2600E−02 | 2.5110E−03 | 1.1364E−02 | −2.0940E−02 | 2.0026E−02 |
| S3 | −6.3800E−03 | 7.1680E−03 | 8.2171E−03 | −1.8750E−02 | 2.0104E−02 |
| S4 | −1.1000E−04 | 6.7430E−03 | −3.0460E−04 | 1.7240E−03 | −7.9600E−03 |
| S5 | −1.5130E−02 | −3.1000E−04 | −1.1158E−02 | 2.5772E−02 | −3.9800E−02 |
| S6 | −2.2420E−02 | 6.8910E−03 | −1.1280E−02 | 9.3520E−03 | −4.2700E−03 |
| S7 | −3.3330E−02 | 2.4105E−02 | −4.2637E−02 | 4.8498E−02 | −3.5620E−02 |
| S8 | −2.9920E−02 | 9.4980E−03 | −7.1521E−03 | 1.3150E−03 | 1.3250E−03 |
| S9 | −4.9630E−02 | 2.2279E−02 | −1.1697E−02 | 4.1260E−03 | −1.3100E−03 |
| S10 | −6.8220E−02 | 2.8191E−02 | −1.0721E−02 | 3.2210E−03 | −7.3000E−04 |
| S11 | −2.6470E−02 | 5.6700E−04 | −1.4302E−04 | −5.0000E−05 | 3.1300E−05 |
| S12 | 2.0606E−02 | −9.5100E−03 | 1.8718E−03 | −2.4000E−04 | 2.1900E−05 |
| S13 | −2.5250E−02 | 2.8960E−03 | 4.5308E−04 | −1.2000E−04 | 1.1200E−05 |
| S14 | −1.9760E−02 | 3.0130E−03 | −4.1187E−04 | 4.4800E−05 | −3.7000E−06 |

| Surface | | | | |
|---|---|---|---|---|
| number | A14 | A16 | A18 | A20 |
| S1 | 3.8540E−03 | −1.3200E−03 | 2.5100E−04 | −2.0630E−05 |
| S2 | −1.1730E−02 | 4.1440E−03 | −8.1000E−04 | 6.5802E−05 |
| S3 | −1.2770E−02 | 4.8850E−03 | −1.0200E−03 | 8.8313E−05 |
| S4 | 1.1674E−02 | −8.1200E−03 | 2.8600E−03 | −4.0044E−04 |
| S5 | 3.7235E−02 | −2.0590E−02 | 6.2640E−03 | −8.0397E−04 |
| S6 | 3.6900E−04 | 7.8700E−04 | −3.4000E−04 | 4.3252E−05 |
| S7 | 1.6245E−02 | −4.2800E−03 | 5.8900E−04 | −3.2568E−05 |
| S8 | −1.1300E−03 | 3.8100E−04 | −6.0000E−05 | 3.4973E−06 |
| S9 | 3.8000E−04 | −9.0000E−05 | 1.3100E−05 | −7.9935E−07 |
| S10 | 1.2100E−04 | −1.3000E−05 | 8.3200E−07 | −2.2371E−08 |
| S11 | −5.2000E−06 | 3.9600E−07 | −1.5000E−08 | 2.2658E−10 |
| S12 | −1.5000E−06 | 6.8700E−08 | −1.8000E−09 | 2.1387E−11 |
| S13 | −5.7000E−07 | 1.6700E−08 | −2.6000E−10 | 1.5701E−12 |
| S14 | 2.0800E−07 | −7.2000E−09 | 1.3900E−10 | −1.1315E−12 |

FIG. 10A shows a longitudinal aberration curve of the optical imaging lens assembly according to embodiment 5. The curve shows common focus-point migration after light rays of different wavelengths pass through the lens. FIG. 10B shows an astigmatic curve of the optical imaging lens assembly according to embodiment 5. The curve shows curvature of meridianal image surface and curvature of sagittal image surface. FIG. 10C shows a distortion curve of the optical imaging lens assembly according to embodiment 5. The curve shows distortion values corresponding to different image heights. FIG. 10D shows a lateral color curve of the optical imaging lens assembly according to embodiment 5. The curve shows the deviation of different image heights on the imaging surface after the light rays pass through the lens. As we can see from FIGS. 10A to 10D, the optical imaging lens assembly according to embodiment 5 can achieve good imaging quality.

### Embodiment 6

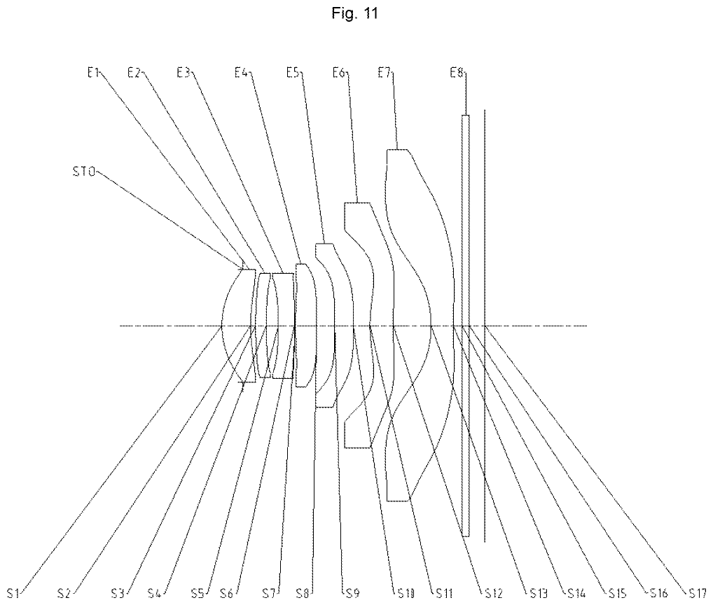

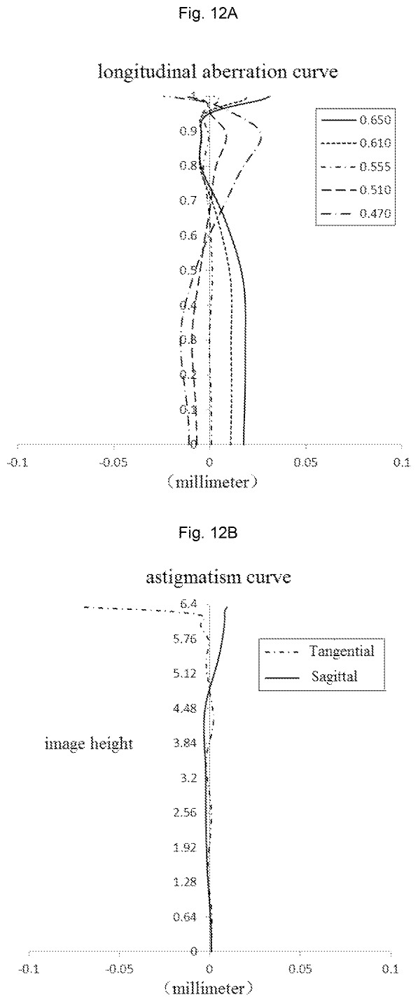

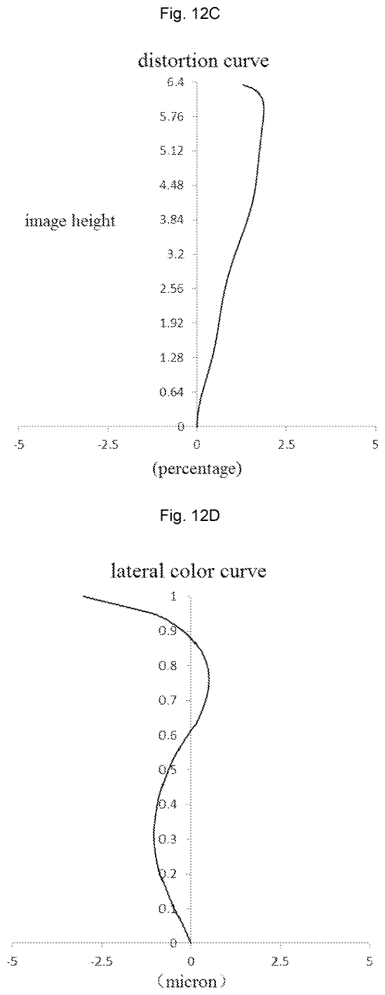

An optical imaging lens assembly according to embodiment 6 of the disclosure is described below with reference to FIG. 11 to FIG. 12D. FIG. 11 shows a structure diagram of an optical imaging lens assembly according to embodiment 6 of the disclosure.

As shown in FIG. 11, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a positive focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a concave surface. The fourth lens E4 has a positive focal power, wherein an object-side surface S7 thereof is a convex surface, and an image-side surface S8 thereof is a convex surface. The fifth lens E5 has a negative focal power, wherein an object-side surface S9 thereof is a concave surface, and an image-side surface 510 thereof is a concave surface. The sixth lens E6 has a positive focal power, wherein an object-side surface S11 thereof is a convex surface, and an image-side surface S12 thereof is a concave surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.62 mm; TTL is the distance from the object-side surface S1 of the first lens E1 to the imaging surface S17 on the optical axis, TTL is 7.70 mm; ImgH is a half of the diagonal length of the effective pixel region on the imaging surface S17, ImgH is 6.35 mm; and FOV is a maximum field of view of the optical imaging lens assembly, FOV is 86.9°.

Table 11 shows basic parameters of the optical imaging lens assembly according to embodiment 6. The units of curvature radius, thickness/distance, and focal length are millimeters (mm).

TABLE 11

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6051 | | | | | |
| S1 | Aspheric | 2.4846 | 0.8405 | 1.59 | 61.16 | 7.40 | Glass | −0.0519 |
| S2 | Aspheric | 5.0318 | 0.1444 | | | | | −7.6666 |
| S3 | Aspheric | 9.1911 | 0.3100 | 1.92 | 18.90 | 90.91 | Glass | −42.1286 |
| S4 | Aspheric | 10.1423 | 0.3615 | | | | | −9.2323 |
| S5 | Aspheric | −8.3197 | 0.4660 | 1.68 | 19.2 | −10.54 | Plastic | −4.0932 |
| S6 | Aspheric | 51.5679 | 0.0300 | | | | | 99.0000 |
| S7 | Aspheric | 6.4117 | 0.6218 | 1.55 | 56.1 | 10.54 | Plastic | −66.6212 |
| S8 | Aspheric | −54.0164 | 0.5276 | | | | | 99.0000 |
| S9 | Aspheric | −71.8100 | 0.5445 | 1.57 | 37.3 | −78.27 | Plastic | 99.0000 |
| S10 | Aspheric | 118.3256 | 0.4906 | | | | | 99.0000 |
| S11 | Aspheric | 4.0105 | 0.6816 | 1.55 | 56.1 | 10.10 | Plastic | −1.1110 |
| S12 | Aspheric | 13.8099 | 1.1076 | | | | | −89.1395 |
| S13 | Aspheric | −3.4156 | 0.6500 | 1.54 | 55.7 | −4.78 | Plastic | −1.1395 |
| S14 | Aspheric | 11.0163 | 0.2576 | | | | | −39.6778 |
| S15 | Spherical | Infinite | 0.2100 | 1.52 | 64.2 | | Glass | |
| S16 | Spherical | Infinite | 0.4564 | | | | | |
| S17 | Spherical | Infinite | | | | | | |

In embodiment 6, an object-side surface and an image-side surface of any one of the first lens E1 to the seventh lens E7 are aspheric surfaces. Table 12 below provides higher-order coefficients A₄, A₆, A₈, A₁₀, A₁₂, A₁₄, A₁₆, A₁₃, and A₂₀ that may be used for aspheric lens surfaces S1-S14 in embodiment 6.

TABLE 12

| Surface | | | | | |
|---|---|---|---|---|---|
| number | A4 | A6 | A8 | A10 | A12 |
| S1 | 1.1020E−03 | −4.8634E−04 | 4.4400E−04 | 1.1100E−04 | −4.4814E−04 |
| S2 | −1.0590E−02 | −2.0924E−03 | −8.3000E−04 | 3.6390E−03 | −3.1921E−03 |
| S3 | −1.1970E−02 | 9.7352E−04 | 8.0600E−03 | −8.3200E−03 | 9.3162E−03 |
| S4 | −5.3500E−03 | 4.8497E−04 | 2.3270E−02 | −4.7440E−02 | 6.4198E−02 |
| S5 | −6.5700E−03 | 1.9418E−03 | −3.4300E−03 | −9.6300E−03 | 2.5530E−02 |
| S6 | −7.4880E−02 | 1.2848E−01 | −1.7661E−01 | 1.7761E−01 | −1.2371E−01 |
| S7 | −7.0990E−02 | 1.2139E−01 | −1.7108E−01 | 1.6923E−01 | −1.1500E−01 |
| S8 | −1.7670E−02 | −3.6020E−03 | 6.0500E−03 | −1.0290E−02 | 9.3465E−03 |
| S9 | −3.8180E−02 | 1.9919E−02 | −2.2600E−02 | 1.8231E−02 | −1.0905E−02 |
| S10 | −6.2450E−02 | 2.8931E−02 | −1.7430E−02 | 8.7550E−03 | −3.3659E−03 |
| S11 | −4.1500E−02 | 4.4006E−03 | −1.0400E−03 | 2.7300E−04 | −1.1312E−04 |
| S12 | −3.9000E−04 | −9.1335E−03 | 3.8820E−03 | −1.0500E−03 | 1.8456E−04 |
| S13 | −2.4630E−02 | 3.0311E−03 | 6.0700E−04 | −1.6000E−04 | 1.6339E−05 |
| S14 | −2.2370E−02 | 4.0955E−03 | −5.0000E−04 | 4.3300E−05 | −2.7653E−06 |

| Surface | | | | |
|---|---|---|---|---|
| number | A14 | A16 | A18 | A20 |
| S1 | 2.4200E−04 | −4.0000E−05 | −7.7000E−06 | 2.0000E−06 |
| S2 | 1.7530E−03 | −7.3000E−04 | 1.9000E−04 | −2.1000E−05 |
| S3 | −7.5100E−03 | 3.5160E−03 | −8.7000E−04 | 9.0700E−05 |
| S4 | −5.5280E−02 | 2.8488E−02 | −8.0400E−03 | 9.6300E−04 |
| S5 | −2.8400E−02 | 1.6526E−02 | −4.9800E−03 | 6.1600E−04 |
| S6 | 5.7925E−02 | −1.7440E−02 | 3.0800E−03 | −2.4000E−04 |
| S7 | 5.2448E−02 | −1.5380E−02 | 2.6210E−03 | −2.0000E−04 |
| S8 | −5.0600E−03 | 1.6280E−03 | −2.9000E−04 | 2.2700E−05 |
| S9 | 4.2770E−03 | −1.0100E−03 | 1.3100E−04 | −7.0000E−06 |
| S10 | 8.8800E−04 | −1.4000E−04 | 1.2200E−05 | −4.3000E−07 |
| S11 | 2.8900E−05 | −3.6000E−06 | 2.1300E−07 | −4.8000E−09 |
| S12 | −2.0000E−05 | 1.3100E−06 | −4.6000E−08 | 6.9200E−10 |
| S13 | −9.2000E−07 | 3.0200E−08 | −5.5000E−10 | 4.2500E−12 |
| S14 | 1.2400E−07 | −3.6000E−09 | 5.9300E−11 | −4.3000E−13 |

FIG. 12A shows a longitudinal aberration curve of the optical imaging lens assembly according to embodiment 6. The curve shows common focus-point migration after light rays of different wavelengths pass through the lens. FIG. 12B shows an astigmatic curve of the optical imaging lens assembly according to embodiment 6. The curve shows curvature of meridianal image surface and curvature of sagittal image surface. FIG. 12C shows a distortion curve of the optical imaging lens assembly according to embodiment 6. The curve shows distortion values corresponding to different image heights. FIG. 12D shows a lateral color curve of the optical imaging lens assembly according to embodiment 6. The curve shows the deviation of different image heights on the imaging surface after the light rays pass through the lens. As we can see from FIGS. 12A to 12D, the optical imaging lens assembly according to embodiment 6 can achieve good imaging quality.

### Embodiment 7

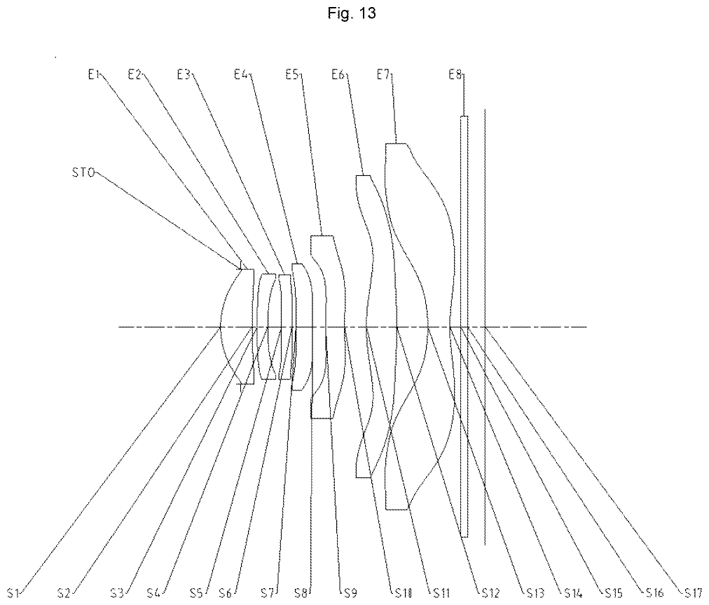

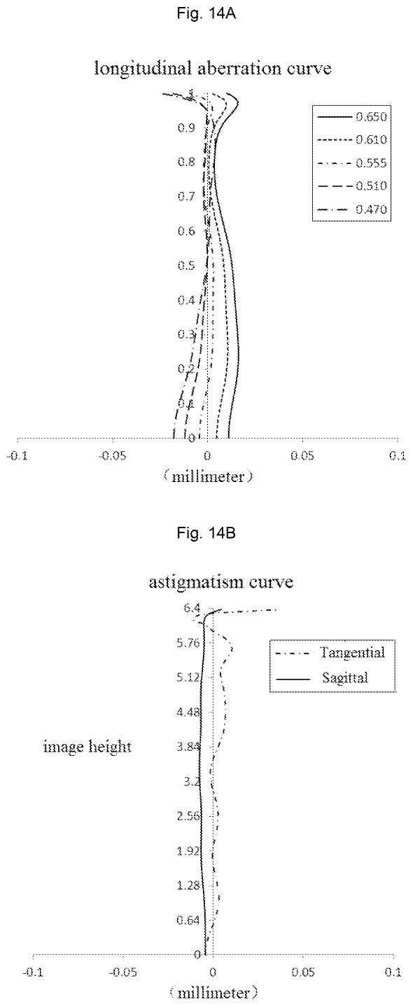

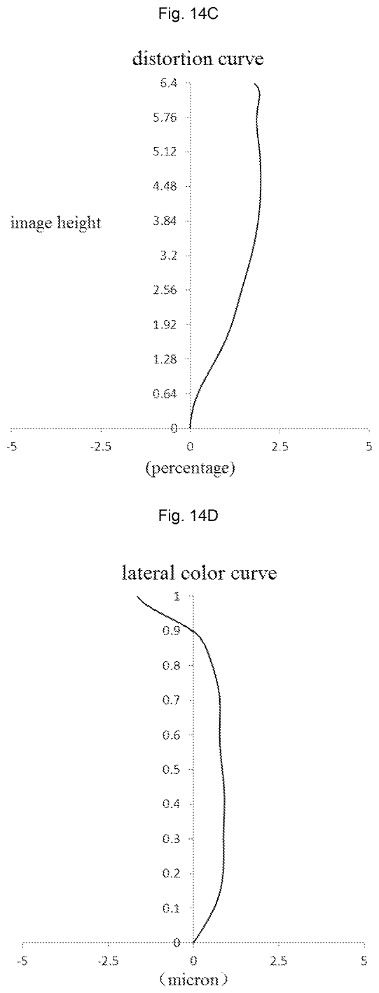

An optical imaging lens assembly according to embodiment 7 of the disclosure is described below with reference to FIG. 13 to FIG. 14D. FIG. 13 shows a structure diagram of an optical imaging lens assembly according to embodiment 7 of the disclosure.

As shown in FIG. 13, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a positive focal power, wherein an object-side surface S5 thereof is a convex surface, and an image-side surface S6 thereof is a concave surface. The fourth lens E4 has a negative focal power, wherein an object-side surface S7 thereof is a convex surface, and an image-side surface S8 thereof is a concave surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.68 mm; TTL is the distance from the object-side surface S1 of the first lens E1 to the imaging surface S17 on the optical axis, TTL is 7.80 mm; ImgH is a half of the diagonal length of the effective pixel region on the imaging surface S17, ImgH is 6.38 mm; and FOV is a maximum field of view of the optical imaging lens assembly, FOV is 86.3°.

Table 13 shows basic parameters of the optical imaging lens assembly according to embodiment 7. The units of curvature radius, thickness/distance, and focal length are millimeters (mm).

TABLE 13

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6016 | | | | | |
| S1 | Aspheric | 2.4532 | 0.9265 | 1.57 | 62.96 | 5.14 | Glass | −0.0965 |
| S2 | Aspheric | 12.9905 | 0.1512 | | | | | −5.2029 |
| S3 | Aspheric | 24.0678 | 0.3100 | 1.85 | 23.79 | −11.28 | Glass | 97.6670 |
| S4 | Aspheric | 6.8333 | 0.4092 | | | | | 9.2599 |
| S5 | Aspheric | 251.3063 | 0.3100 | 1.67 | 20.4 | 2914.12 | Plastic | −99.0000 |
| S6 | Aspheric | 288.4723 | 0.1131 | | | | | −99.0000 |
| S7 | Aspheric | 157.0552 | 0.4944 | 1.55 | 56.1 | −140.83 | Plastic | −99.0000 |
| S8 | Aspheric | 51.5583 | 0.3797 | | | | | −99.0000 |
| S9 | Aspheric | 9.0592 | 0.5592 | 1.57 | 37.3 | −145.74 | Plastic | 15.1912 |
| S10 | Aspheric | 7.9858 | 0.6430 | | | | | −2.8260 |
| S11 | Aspheric | 5.1192 | 0.8998 | 1.55 | 56.1 | 6.65 | Plastic | 0.0270 |
| S12 | Aspheric | −11.6958 | 0.9107 | | | | | −99.0000 |
| S13 | Aspheric | −4.8172 | 0.6500 | 1.54 | 55.7 | −4.43 | Plastic | −0.8135 |
| S14 | Aspheric | 4.9080 | 0.3172 | | | | | −17.2365 |
| S15 | Spherical | Infinite | 0.2100 | 1.52 | 64.2 | | Glass | |
| S16 | Spherical | Infinite | 0.5160 | | | | | |
| S17 | Spherical | Infinite | | | | | | |

In embodiment 7, an object-side surface and an image-side surface of any one of the first lens E1 to the seventh lens E7 are aspheric surfaces. Table 14 below provides higher-order coefficients A₄, A₆, A₈, A₁₀, A₁₂, A₁₄, A₁₆, A₁₈, and A₂₀ that may be used for aspheric lens surfaces S1-S14 in embodiment 7.

TABLE 14

| Surface | | | | | |
|---|---|---|---|---|---|
| number | A4 | A6 | A8 | A10 | A12 |
| S1 | −1.1000E−04 | 3.8930E−03 | −7.6579E−03 | 8.9460E−03 | −6.7700E−03 |
| S2 | −9.2200E−03 | 3.0670E−03 | 2.6098E−03 | −7.6800E−03 | 7.9640E−03 |
| S3 | −1.8400E−03 | 1.1007E−02 | −1.8085E−04 | −9.9300E−03 | 1.3593E−02 |
| S4 | 4.7340E−03 | 8.3820E−03 | 3.7408E−03 | −1.6450E−02 | 2.1978E−02 |
| S5 | −1.3600E−02 | −1.3930E−02 | 3.0656E−02 | −5.3430E−02 | 6.1308E−02 |
| S6 | −7.6200E−03 | −1.9130E−02 | 3.4645E−02 | −4.7850E−02 | 4.5706E−02 |
| S7 | −1.1870E−02 | −1.3240E−02 | 2.8262E−02 | −4.6010E−02 | 4.6141E−02 |
| S8 | −3.3960E−02 | 1.9633E−02 | −2.2089E−02 | 1.6311E−02 | −9.0100E−03 |
| S9 | −6.2200E−02 | 2.7113E−02 | −1.5245E−02 | 6.0550E−03 | −2.0900E−03 |
| S10 | −5.9340E−02 | 2.1791E−02 | −7.9492E−03 | 2.1600E−03 | −4.0000E−04 |
| S11 | −1.5670E−02 | 1.4340E−03 | −2.2867E−04 | −1.3000E−05 | 7.9000E−06 |
| S12 | 6.7300E−03 | −2.2500E−03 | 5.2063E−04 | −1.1000E−04 | 1.4500E−05 |
| S13 | −1.9070E−02 | 1.9730E−03 | 3.3890E−04 | −7.8000E−05 | 6.8500E−06 |
| S14 | −1.2680E−02 | 1.2930E−03 | −4.9339E−05 | −5.7000E−06 | 8.8300E−07 |

| Surface | | | | |
|---|---|---|---|---|
| number | A14 | A16 | A18 | A20 |
| S1 | 3.1960E−03 | −9.2000E−04 | 1.4700E−04 | −9.7948E−06 |
| S2 | −4.8600E−03 | 1.7550E−03 | −3.4000E−04 | 2.8142E−05 |
| S3 | −9.5900E−03 | 3.9510E−03 | −8.8000E−04 | 8.1853E−05 |
| S4 | −1.6500E−02 | 7.4400E−03 | −1.8500E−03 | 1.9922E−04 |
| S5 | −4.6110E−02 | 2.1412E−02 | −5.4900E−03 | 5.9327E−04 |
| S6 | −2.8680E−02 | 1.1148E−02 | −2.3700E−03 | 2.0788E−04 |
| S7 | −2.8320E−02 | 1.0285E−02 | −2.0000E−03 | 1.5975E−04 |
| S8 | 3.5000E−03 | −9.0000E−04 | 1.3500E−04 | −8.7111E−06 |
| S9 | 6.4500E−04 | −1.6000E−04 | 2.3700E−05 | −1.4973E−06 |
| S10 | 5.5600E−05 | −5.6000E−06 | 3.5000E−07 | −9.7295E−09 |
| S11 | −9.1000E−07 | 4.9300E−08 | −1.3000E−09 | 1.4532E−11 |
| S12 | −1.2000E−06 | 5.7200E−08 | −1.5000E−09 | 1.6069E−11 |
| S13 | −3.3000E−07 | 9.5100E−09 | −1.5000E−10 | 1.0054E−12 |
| S14 | −5.5000E−08 | 1.8600E−09 | −3.3000E−11 | 2.4059E−13 |

FIG. 14A shows a longitudinal aberration curve of the optical imaging lens assembly according to embodiment 7. The curve shows common focus-point migration after light rays of different wavelengths pass through the lens. FIG. 14B shows an astigmatic curve of the optical imaging lens assembly according to embodiment 7. The curve shows curvature of meridianal image surface and curvature of sagittal image surface. FIG. 14C shows a distortion curve of the optical imaging lens assembly according to embodiment 7. The curve shows distortion values corresponding to different image heights. FIG. 14D shows a lateral color curve of the optical imaging lens assembly according to embodiment 7. The curve shows the deviation of different image heights on the imaging surface after the light rays pass through the lens. As we can see from FIGS. 14A to 14D, the optical imaging lens assembly according to embodiment 7 can achieve good imaging quality.

### Embodiment 8

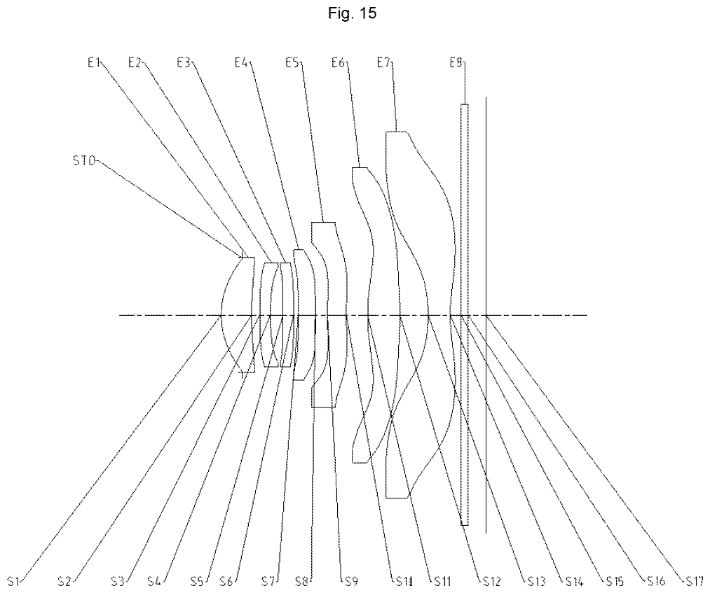

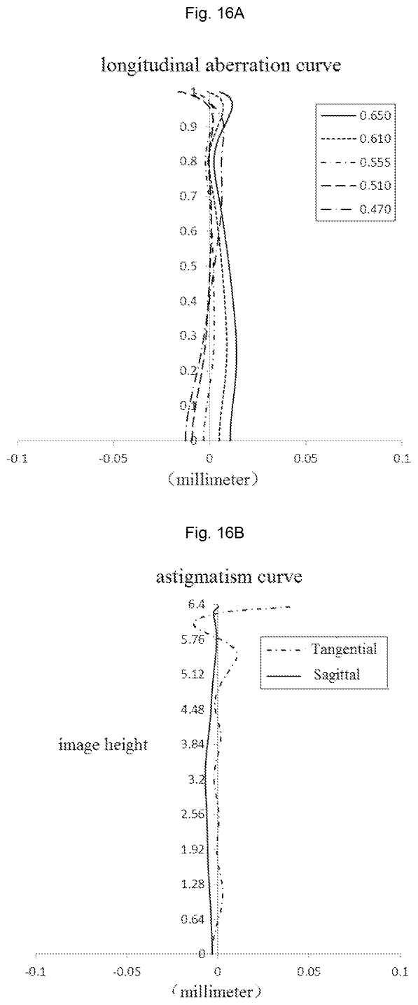

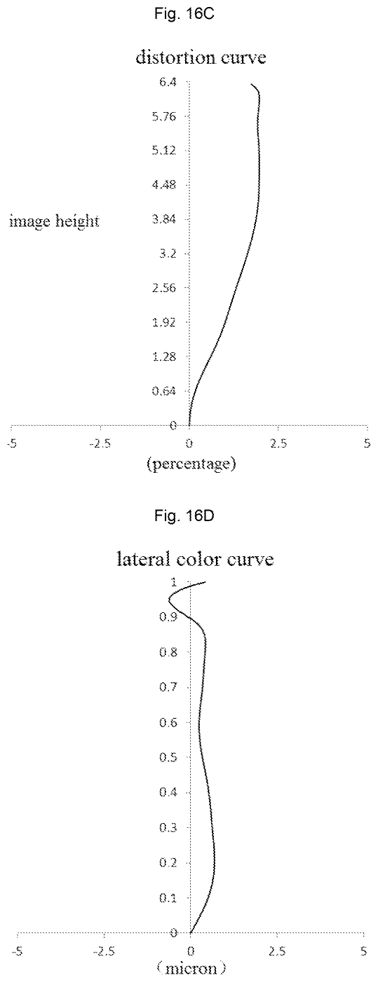

An optical imaging lens assembly according to embodiment 8 of the disclosure is described below with reference to FIG. 15 to FIG. 16D. FIG. 15 shows a structure diagram of an optical imaging lens assembly according to embodiment 8 of the disclosure.

As shown in FIG. 15, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a positive focal power, wherein an object-side surface S5 thereof is a convex surface, and an image-side surface S6 thereof is a convex surface. The fourth lens E4 has a negative focal power, wherein an object-side surface S7 thereof is a convex surface, and an image-side surface S8 thereof is a concave surface. The fifth lens E5 has a negative focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.69 mm; TTL is the distance from the object-side surface S1 of the first lens E1 to the imaging surface S17 on the optical axis, TTL is 7.79 mm; ImgH is a half of the diagonal length of the effective pixel region on the imaging surface S17, ImgH is 6.36 mm; and FOV is a maximum field of view of the optical imaging lens assembly, FOV is 86.1°.

Table 15 shows basic parameters of the optical imaging lens assembly according to embodiment 8. The units of curvature radius, thickness, and focal length are millimeters (mm).

TABLE 15

| | | | | Material | | | | |
|---|---|---|---|---|---|---|---|---|
| Surface | Surface | Curvature | Thicknes/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6066 | | | | | |
| S1 | Aspheric | 2.4706 | 0.8928 | 1.57 | 62.96 | 5.55 | Glass | −0.0831 |
| S2 | Aspheric | 9.7825 | 0.2383 | | | | | −2.9820 |
| S3 | Aspheric | 14.8935 | 0.3100 | 1.93 | 18.90 | −13.95 | Glass | 41.1331 |
| S4 | Aspheric | 6.8710 | 0.3746 | | | | | 8.4596 |
| S5 | Aspheric | 277.7778 | 0.3100 | 1.67 | 20.4 | 215.61 | Plastic | −99.0000 |
| S6 | Aspheric | −298.1870 | 0.1385 | | | | | 99.0000 |
| S7 | Aspheric | 333.2729 | 0.5015 | 1.55 | 56.1 | −140.83 | Plastic | −99.0000 |
| S8 | Aspheric | 62.4382 | 0.3580 | | | | | 79.5149 |
| S9 | Aspheric | 9.1720 | 0.5552 | 1.57 | 37.3 | −165.20 | Plastic | 14.7661 |
| S10 | Aspheric | 8.1747 | 0.6280 | | | | | −2.3685 |
| S11 | Aspheric | 5.4845 | 0.9485 | 1.55 | 56.1 | 6.72 | Plastic | 0.0998 |
| S12 | Aspheric | −10.4275 | 0.8312 | | | | | −38.0863 |
| S13 | Aspheric | −4.9485 | 0.6500 | 1.54 | 55.7 | −4.28 | Plastic | −0.7658 |
| S14 | Aspheric | 4.4847 | 0.3201 | | | | | −16.3277 |
| S15 | Spherical | Infinite | 0.2100 | 1.52 | 64.2 | | Glass | |
| S16 | Spherical | Infinite | 0.5190 | | | | | |
| S17 | Spherical | Infinite | | | | | | |

In embodiment 8, an object-side surface and an image-side surface of any one of the first lens E1 to the seventh lens E7 are aspheric surfaces. Table 16 below provides higher-order coefficients A₄, A₆, A₈, A₁₀, A₁₂, A₁₄, A₁₆, A₁₈, and A₂₀ that may be used for aspheric lens surfaces S1-S14 in embodiment 8.

TABLE 16

| Surface | | | | | |
|---|---|---|---|---|---|
| number | A4 | A6 | A8 | A10 | A12 |
| S1 | −2.3700E−05 | 2.2633E−03 | −4.6600E−03 | 5.5330E−03 | −4.3483E−03 |
| S2 | −6.4090E−03 | −1.0524E−06 | 2.6330E−03 | −4.9700E−03 | 4.8307E−03 |
| S3 | −1.5710E−03 | 6.5863E−03 | 5.7900E−04 | −4.2600E−03 | 5.2776E−03 |
| S4 | 4.0811E−03 | 5.2099E−03 | 7.6980E−03 | −1.8910E−02 | 2.4156E−02 |
| S5 | −1.2086E−02 | −2.5973E−02 | 6.6332E−02 | −1.1876E−01 | 1.3626E−01 |
| S6 | −7.1130E−03 | −3.6831E−02 | 7.0646E−02 | −9.7000E−02 | 8.8593E−02 |
| S7 | −9.5010E−03 | −2.3072E−02 | 3.5336E−02 | −4.4830E−02 | 3.8777E−02 |
| S8 | −2.8989E−02 | 1.0858E−02 | −1.3100E−02 | 9.8750E−03 | −5.9275E−03 |
| S9 | −5.5752E−02 | 1.9632E−02 | −9.7300E−03 | 3.3610E−03 | −1.2257E−03 |
| S10 | −5.2990E−02 | 1.5783E−02 | −4.3800E−03 | 8.1800E−04 | −9.3670E−05 |
| S11 | −1.2336E−02 | −1.1733E−03 | 6.3000E−04 | −1.9000E−04 | 3.0859E−05 |
| S12 | 1.3353E−02 | −5.7447E−03 | 1.4620E−03 | −2.6000E−04 | 3.1829E−05 |
| S13 | −2.0701E−02 | 2.1920E−03 | 3.8500E−04 | −9.2000E−05 | 8.3282E−06 |
| S14 | −1.4880E−02 | 1.9836E−03 | −1.7000E−04 | 7.9900E−06 | −1.1866E−07 |

| Surface | | | | |
|---|---|---|---|---|
| number | A14 | A16 | A18 | A20 |
| S1 | 2.1580E−03 | −6.7000E−04 | 1.1500E−04 | −8.5832E−06 |
| S2 | −2.8800E−03 | 1.0200E−03 | −1.9000E−04 | 1.5310E−05 |
| S3 | −3.5900E−03 | 1.4580E−03 | −3.2000E−04 | 2.7740E−05 |
| S4 | −1.8780E−02 | 8.9190E−03 | −2.3500E−03 | 2.6762E−04 |
| S5 | −1.0020E−01 | 4.5360E−02 | −1.1450E−02 | 1.2356E−03 |
| S6 | −5.2270E−02 | 1.9109E−02 | −3.8700E−03 | 3.2926E−04 |
| S7 | −2.1710E−02 | 7.5100E−03 | −1.4300E−03 | 1.1280E−04 |
| S8 | 2.5510E−03 | −7.2000E−04 | 1.1600E−04 | −7.9817E−06 |
| S9 | 4.3500E−04 | −1.2000E−04 | 1.8300E−05 | −1.1739E−06 |
| S10 | 1.1800E−05 | −1.9000E−06 | 1.7800E−07 | −6.3646E−09 |
| S11 | −2.7000E−06 | 1.3500E−07 | −3.5000E−09 | 3.7067E−11 |
| S12 | −2.4000E−06 | 1.1400E−07 | −2.9000E−09 | 3.2379E−11 |
| S13 | −4.2000E−07 | 1.2300E−08 | −2.0000E−10 | 1.3856E−12 |
| S14 | −8.1000E−09 | 5.2900E−10 | −1.2000E−11 | 1.0400E−13 |

FIG. 16A shows a longitudinal aberration curve of the optical imaging lens assembly according to embodiment 8. The curve shows common focus-point migration after light rays of different wavelengths pass through the lens. FIG. 16B shows an astigmatic curve of the optical imaging lens assembly according to embodiment 8. The curve shows curvature of meridianal image surface and curvature of sagittal image surface. FIG. 16C shows a distortion curve of the optical imaging lens assembly according to embodiment 8. The curve shows distortion values corresponding to different image heights. FIG. 16D shows a lateral color curve of the optical imaging lens assembly according to embodiment 8. The curve shows the deviation of different image heights on the imaging surface after the light rays pass through the lens. As we can see from FIGS. 16A to 16D, the optical imaging lens assembly according to embodiment 8 can achieve good imaging quality.

### Embodiment 9

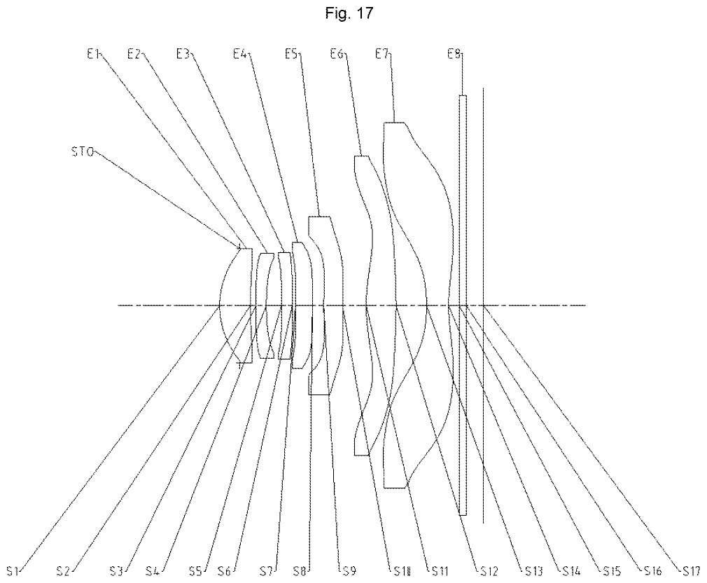

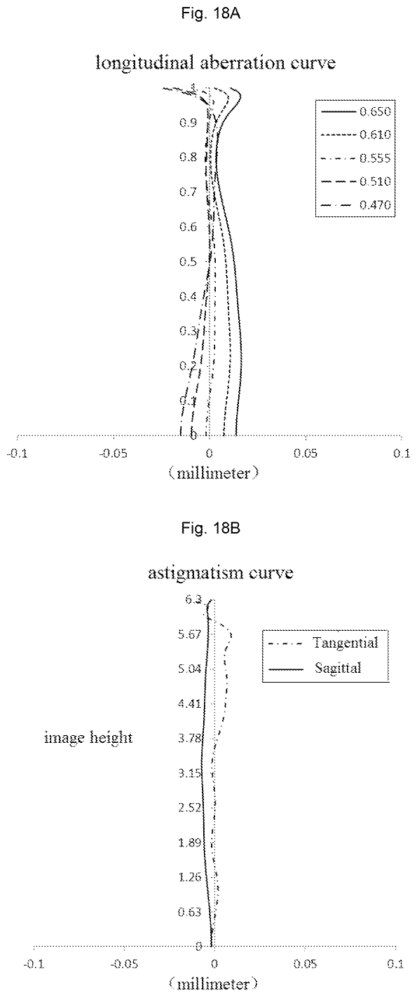

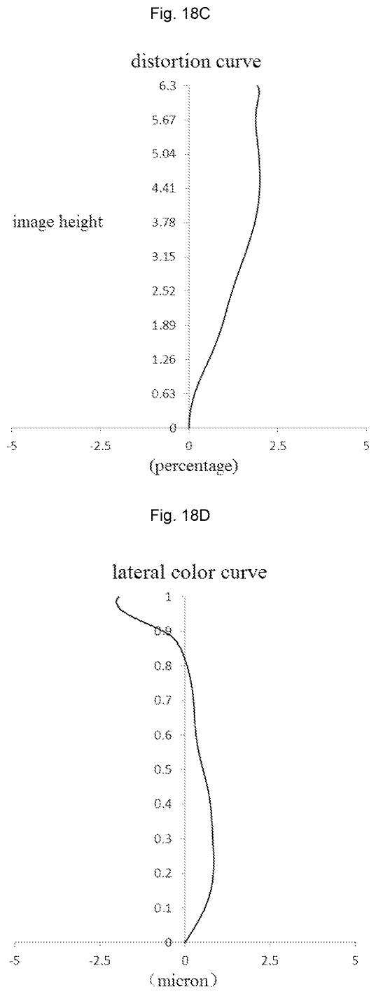

An optical imaging lens assembly according to embodiment 9 of the disclosure is described below with reference to FIG. 17 to FIG. 18D. FIG. 17 shows a structure diagram of an optical imaging lens assembly according to embodiment 9 of the disclosure.

As shown in FIG. 17, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a concave surface. The fourth lens E4 has a negative focal power, wherein an object-side surface S7 thereof is a convex surface, and an image-side surface S8 thereof is a concave surface. The fifth lens E5 has a positive focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.68 mm; TTL is the distance from the object-side surface S1 of the first lens E1 to the imaging surface S17 on the optical axis, TTL is 7.80 mm; ImgH is a half of the diagonal length of the effective pixel region on the imaging surface S17, ImgH is 6.30 mm; and FOV is a maximum field of view of the optical imaging lens assembly, FOV is 85.5°.

Table 17 shows basic parameters of the optical imaging lens assembly according to embodiment 9. The units of curvature radius, thickness, and focal length are millimeters (mm).

TABLE 17

| | | | | Material | | | | |
|---|---|---|---|---|---|---|---|---|
| Surface | Surface | Curvature | Thickness/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.5943 | | | | | |
| S1 | Aspheric | 2.4804 | 0.9092 | 1.57 | 62.96 | 5.35 | Glass | −0.0915 |
| S2 | Aspheric | 11.5120 | 0.1586 | | | | | −8.5978 |
| S3 | Aspheric | 20.7501 | 0.3100 | 1.81 | 22.69 | −13.66 | Glass | 55.9517 |
| S4 | Aspheric | 7.1926 | 0.4475 | | | | | 9.1387 |
| S5 | Aspheric | −182.8800 | 0.3190 | 1.67 | 20.4 | −99.01 | Plastic | 99.0000 |
| S6 | Aspheric | 103.4666 | 0.0957 | | | | | −99.0000 |
| S7 | Aspheric | 90.0536 | 0.4982 | 1.55 | 56.1 | −140.83 | Plastic | −99.0000 |
| S8 | Aspheric | 41.3934 | 0.3362 | | | | | −32.7492 |
| S9 | Aspheric | 8.8509 | 0.5532 | 1.57 | 37.3 | 248.79 | Plastic | 13.7686 |
| S10 | Aspheric | 9.2254 | 0.7008 | | | | | −2.5516 |
| S11 | Aspheric | 5.2290 | 0.8839 | 1.55 | 56.1 | 6.90 | Plastic | 0.0493 |
| S12 | Aspheric | −12.6840 | 0.9000 | | | | | −77.5023 |
| S13 | Aspheric | −4.7415 | 0.6500 | 1.54 | 55.7 | −4.38 | Plastic | −0.8205 |
| S14 | Aspheric | 4.8929 | 0.3144 | | | | | −18.0954 |
| S15 | Spherical | Infinite | 0.2100 | 1.52 | 64.2 | | Glass | |
| S16 | Spherical | Infinite | 0.5133 | | | | | |
| S17 | Spherical | Infinite | | | | | | |

In embodiment 9, an object-side surface and an image-side surface of any one of the first lens E1 to the seventh lens E7 are aspheric surfaces. Table 18 below provides higher-order coefficients A₄, A₆, A₈, A₁₀, A₁₂, A₁₄, A₁₆, A₁₈, and A₂₀ that may be used for aspheric lens surfaces S1-S14 in embodiment 9.

TABLE 18

| Surface | | | | | |
|---|---|---|---|---|---|
| number | A4 | A6 | A8 | A10 | A12 |
| S1 | 9.2090E−06 | 3.2160E−03 | −6.4234E−03 | 7.5550E−03 | −5.7659E−03 |
| S2 | −8.8580E−03 | 1.9670E−03 | 2.8455E−03 | −6.7500E−03 | 6.7036E−03 |
| S3 | −2.8960E−03 | 9.3290E−03 | 1.6016E−03 | −1.0070E−02 | 1.2504E−02 |
| S4 | 4.2686E−03 | 8.3290E−03 | 1.5168E−03 | −8.8000E−03 | 1.1230E−02 |
| S5 | −1.3898E−02 | −1.5810E−02 | 3.5896E−02 | −5.8800E−02 | 6.4241E−02 |
| S6 | −7.7900E−03 | −2.5030E−02 | 4.3115E−02 | −5.4040E−02 | 4.8048E−02 |
| S7 | −9.5780E−03 | −1.7960E−02 | 3.0398E−02 | −4.2840E−02 | 4.0766E−02 |
| S8 | −3.4764E−02 | 1.9721E−02 | −1.9723E−02 | 1.2282E−02 | −5.5589E−03 |
| S9 | −6.3880E−02 | 2.5443E−02 | −1.1426E−02 | 2.0300E−03 | 3.8374E−04 |
| S10 | −5.7105E−02 | 1.9231E−02 | −6.0829E−03 | 1.2690E−03 | −1.3091E−04 |
| S11 | −1.3650E−02 | 3.3700E−06 | 2.2136E−04 | −9.4000E−05 | 1.6681E−05 |
| S12 | 1.0184E−02 | −4.4800E−03 | 1.1388E−03 | −2.1000E−04 | 2.4941E−05 |
| S13 | −1.9170E−02 | 2.0000E−03 | 3.4374E−04 | −8.0000E−05 | 7.0098E−06 |
| S14 | −1.3533E−02 | 1.6030E−03 | −1.0258E−04 | 2.6500E−07 | 4.3980E−07 |

| Surface | | | | |
|---|---|---|---|---|
| number | A14 | A16 | A18 | A20 |
| S1 | 2.7410E−03 | −8.0000E−04 | 1.2700E−04 | −8.5880E−06 |
| S2 | −4.0300E−03 | 1.4410E−03 | −2.8000E−04 | 2.2675E−05 |
| S3 | −8.5100E−03 | 3.4280E−03 | −7.5000E−04 | 6.8585E−05 |
| S4 | −8.0000E−03 | 3.5210E−03 | −8.7000E−04 | 9.7748E−05 |
| S5 | −4.6510E−02 | 2.1004E−02 | −5.2900E−03 | 5.6745E−04 |
| S6 | −2.8650E−02 | 1.0691E−02 | −2.2000E−03 | 1.8800E−04 |
| S7 | −2.4500E−02 | 8.8080E−03 | −1.7000E−03 | 1.3519E−04 |
| S8 | 1.7880E−03 | −4.0000E−04 | 5.5000E−05 | −3.3067E−06 |
| S9 | −3.1000E−04 | 6.9300E−05 | −6.8000E−06 | 2.7696E−07 |
| S10 | 3.9100E−06 | 2.5700E−07 | −1.4000E−08 | −5.3234E−11 |
| S11 | −1.5000E−06 | 7.1600E−08 | −1.8000E−09 | 1.8461E−11 |
| S12 | −1.9000E−06 | 8.6600E−08 | −2.2000E−09 | 2.3367E−11 |
| S13 | −3.4000E−07 | 9.7800E−09 | −1.5000E−10 | 1.0312E−12 |
| S14 | −3.4000E−08 | 1.2500E−09 | −2.3000E−11 | 1.7246E−13 |

FIG. 18A shows a longitudinal aberration curve of the optical imaging lens assembly according to embodiment 9. The curve shows common focus-point migration after light rays of different wavelengths pass through the lens. FIG. 18B shows an astigmatic curve of the optical imaging lens assembly according to embodiment 9. The curve shows curvature of meridianal image surface and curvature of sagittal image surface. FIG. 18C shows a distortion curve of the optical imaging lens assembly according to embodiment 9. The curve shows distortion values corresponding to different image heights. FIG. 18D shows a lateral color curve of the optical imaging lens assembly according to embodiment 9. The curve shows the deviation of different image heights on the imaging surface after the light rays pass through the lens. As we can see from FIGS. 18A to 18D, the optical imaging lens assembly according to embodiment 9 can achieve good imaging quality.

### Embodiment 10

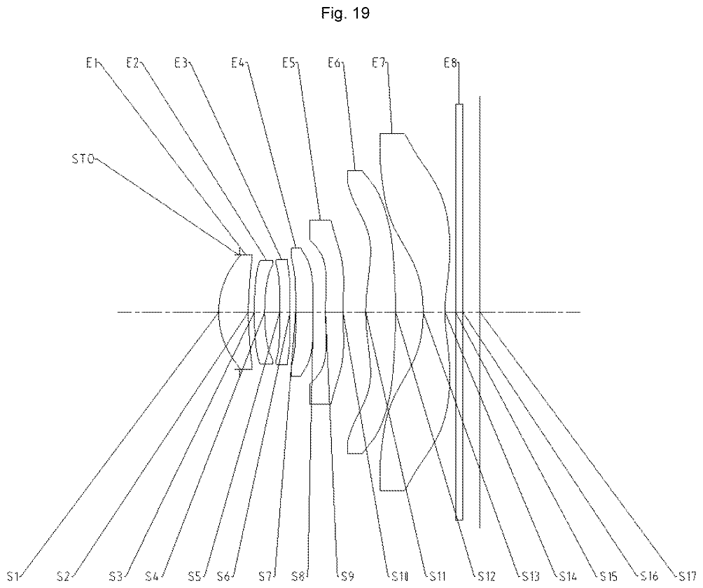

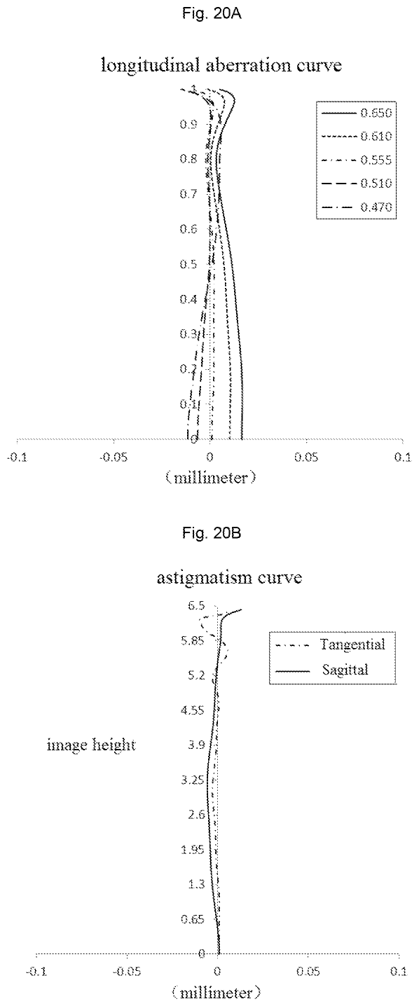

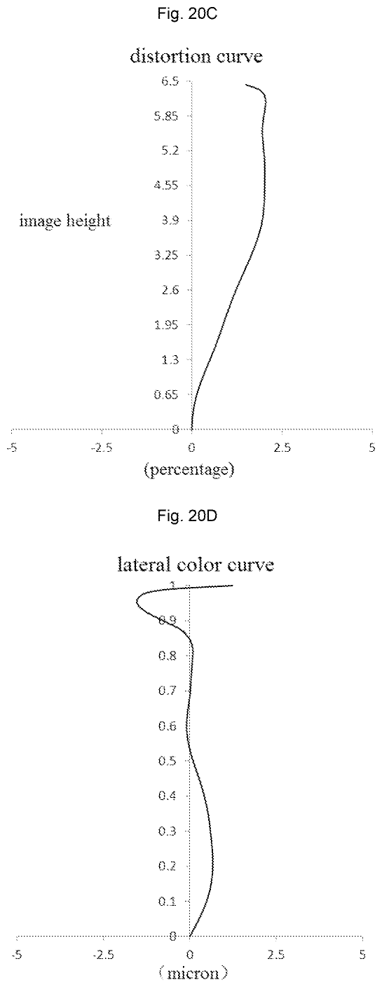

An optical imaging lens assembly according to embodiment 10 of the disclosure is described below with reference to FIG. 19 to FIG. 20D. FIG. 19 shows a structure diagram of an optical imaging lens assembly according to embodiment 10 of the disclosure.

As shown in FIG. 19, the optical imaging lens assembly sequentially includes the followings from an object side to an image side along an optical axis: a diaphragm STO, a first lens E1, a second lens E2, a third lens E3, a fourth lens E4, a fifth lens E5, a sixth lens E6, a seventh lens E7, an optical filter E8, and an imaging surface S17.

The first lens E1 has a positive focal power, wherein an object-side surface S1 thereof is a convex surface, and an image-side surface S2 thereof is a concave surface. The second lens E2 has a negative focal power, wherein an object-side surface S3 thereof is a convex surface, and an image-side surface S4 thereof is a concave surface. The third lens E3 has a negative focal power, wherein an object-side surface S5 thereof is a concave surface, and an image-side surface S6 thereof is a concave surface. The fourth lens E4 has a positive focal power, wherein an object-side surface S7 thereof is a concave surface, and an image-side surface S8 thereof is a convex surface. The fifth lens E5 has a positive focal power, wherein an object-side surface S9 thereof is a convex surface, and an image-side surface S10 thereof is a concave surface. The sixth lens E6 has a positive focal power, wherein an object-side surface S11 thereof is a convex surface, and an image-side surface S12 thereof is a convex surface. The seventh lens E7 has a negative focal power, wherein an object-side surface S13 thereof is a concave surface, and an image-side surface S14 thereof is a concave surface. The optical filter E8 has an object-side surface S15 and an image-side surface S16. Light from an object passes through the respective surfaces S1 to S16 in sequence and is finally imaged on the imaging surface S17.

In this embodiment, the total effective focal length f of the optical imaging lens assembly is 6.69 mm; TTL is the distance from the object-side surface S1 of the first lens E1 to the imaging surface S17 on the optical axis, TTL is 7.77 mm; ImgH is a half of the diagonal length of the effective pixel region on the imaging surface S17, ImgH is 6.43 mm; and FOV is a maximum field of view of the optical imaging lens assembly, FOV is 86.9°.

Table 19 shows basic parameters of the optical imaging lens assembly according to embodiment 10. The units of curvature radius, thickness, and focal length are millimeters (mml.

TABLE 19

| | | | | Material | | | | |
|---|---|---|---|---|---|---|---|---|
| Surface | Surface | Curvature | Thickness/ | Refractive | Abbe | Focal | | Conic |
| number | type | radius | distance | index | number | length | Material | coefficient |
| OBJ | Spherical | Infinite | Infinite | | | | | |
| STO | Spherical | Infinite | −0.6165 | | | | | |
| S1 | Aspheric | 2.4814 | 0.8802 | 1.57 | 62.96 | 5.78 | Glass | −0.0335 |
| S2 | Aspheric | 8.7438 | 0.1758 | | | | | −2.1844 |
| S3 | Aspheric | 10.7912 | 0.3100 | 1.93 | 18.90 | −17.30 | Glass | 12.5191 |
| S4 | Aspheric | 6.3744 | 0.4478 | | | | | 6.3278 |
| S5 | Aspheric | −249.8479 | 0.3100 | 1.67 | 20.4 | −99.01 | Plastic | 99.0000 |
| S6 | Aspheric | 89.8326 | 0.1647 | | | | | −99.0000 |
| S7 | Aspheric | −90.9091 | 0.5241 | 1.55 | 56.1 | 158.00 | Plastic | 99.0000 |
| S8 | Aspheric | −44.3520 | 0.3615 | | | | | 99.0000 |
| S9 | Aspheric | 8.7801 | 0.5197 | 1.57 | 37.3 | 214.18 | Plastic | 12.7772 |
| S10 | Aspheric | 9.2566 | 0.6790 | | | | | −1.3852 |
| S11 | Aspheric | 5.9256 | 0.8871 | 1.55 | 56.1 | 7.39 | Plastic | 0.2871 |
| S12 | Aspheric | −11.9615 | 0.8171 | | | | | −28.0847 |
| S13 | Aspheric | −4.8367 | 0.6500 | 1.54 | 55.7 | −4.21 | Plastic | −0.8059 |
| S14 | Aspheric | 4.4456 | 0.3172 | | | | | −16.5757 |
| S15 | Spherical | Infinite | 0.2100 | 1.52 | 64.2 | | Glass | |
| S16 | Spherical | Infinite | 0.5160 | | | | | |
| S17 | Spherical | Infinite | | | | | | |

In embodiment 10, an object-side surface and an image-side surface of any one of the first lens E1 to the seventh lens E7 are aspheric surfaces. Table 20 below provides higher-order coefficients A₄, A₆, A₈, A₁₀, A₁₂, A₁₄, A₁₆, A₁₈, and A₂₀ that may be used for aspheric lens surfaces S1-S14 in embodiment 10.

TABLE 20

| Surface | | | | | |
|---|---|---|---|---|---|
| number | A4 | A6 | A8 | A10 | A12 |
| S1 | 5.3300E−05 | 2.2564E−03 | −4.8101E−03 | 6.1170E−03 | −4.9901E−03 |
| S2 | −7.7940E−03 | 1.8252E−03 | 1.3282E−03 | −3.2800E−03 | 3.2682E−03 |
| S3 | −3.3600E−03 | 6.9794E−03 | 1.5171E−03 | −6.0300E−03 | 6.9237E−03 |
| S4 | 2.7654E−03 | 6.8010E−03 | 1.9664E−03 | −6.7400E−03 | 7.9786E−03 |
| S5 | −1.9251E−02 | −1.6863E−02 | 4.1352E−02 | −6.8110E−02 | 7.1806E−02 |
| S6 | −1.4851E−02 | −2.4931E−02 | 4.6760E−02 | −6.0780E−02 | 5.2702E−02 |
| S7 | −6.8220E−03 | −2.1603E−02 | 3.1014E−02 | −3.7090E−02 | 3.0130E−02 |
| S8 | −2.2637E−02 | 2.0979E−03 | −1.6868E−03 | −5.6000E−04 | 7.1495E−04 |
| S9 | −4.6893E−02 | 8.4680E−03 | 1.1470E−03 | −4.5800E−03 | 2.9334E−03 |
| S10 | −4.3970E−02 | 8.9001E−03 | −2.7902E−04 | −1.0200E−03 | 4.7013E−04 |
| S11 | −9.1970E−03 | −3.3033E−03 | 1.3496E−03 | −3.5000E−04 | 5.3618E−05 |
| S12 | 1.5960E−02 | −7.8715E−03 | 2.1478E−03 | −3.9000E−04 | 4.7784E−05 |
| S13 | −2.2003E−02 | 2.3989E−03 | 4.3235E−04 | −1.1000E−04 | 9.9402E−06 |
| S14 | −1.6612E−02 | 2.6149E−03 | −2.8589E−04 | 2.1600E−05 | −1.2163E−06 |

| Surface | | | | |
|---|---|---|---|---|
| number | A14 | A16 | A18 | A20 |
| S1 | 2.5550E−03 | −8.1000E−04 | 1.4100E−04 | −1.0698E−05 |
| S2 | −1.9900E−03 | 7.1100E−04 | −1.4000E−04 | 1.0438E−05 |
| S3 | −4.5600E−03 | 1.8020E−03 | −3.8000E−04 | 3.3552E−05 |
| S4 | −5.4400E−03 | 2.2580E−03 | −5.1000E−04 | 5.0150E−05 |
| S5 | −4.9030E−02 | 2.0810E−02 | −4.9400E−03 | 5.0321E−04 |
| S6 | −2.9660E−02 | 1.0419E−02 | −2.0300E−03 | 1.6601E−04 |
| S7 | −1.5900E−02 | 5.2050E−03 | −9.4000E−04 | 7.0549E−05 |
| S8 | −2.8000E−04 | 5.5300E−05 | −5.0000E−06 | 2.6583E−07 |
| S9 | −1.0400E−03 | 2.1800E−04 | −2.6000E−05 | 1.3333E−06 |
| S10 | −9.9000E−05 | 1.1400E−05 | −6.9000E−07 | 1.7620E−08 |
| S11 | −4.8000E−06 | 2.4200E−07 | −6.6000E−09 | 7.5349E−11 |
| S12 | −3.7000E−06 | 1.7600E−07 | −4.7000E−09 | 5.3272E−11 |
| S13 | −5.1000E−07 | 1.5600E−08 | −2.6000E−10 | 1.8682E−12 |
| S14 | 4.9800E−08 | −1.3000E−09 | 2.0700E−11 | −1.3995E−13 |

FIG. 20A shows a longitudinal aberration curve of the optical imaging lens assembly according to embodiment 10. The curve shows common focus-point migration after light rays of different wavelengths pass through the lens. FIG. 20B shows an astigmatic curve of the optical imaging lens assembly according to embodiment 10. The curve shows curvature of meridianal image surface and curvature of sagittal image surface. FIG. 20C shows a distortion curve of the optical imaging lens assembly according to embodiment 10. The curve shows distortion values corresponding to different image heights. FIG. 20D shows a lateral color curve of the optical imaging lens assembly according to embodiment 10. The curve shows the deviation of different image heights on the imaging surface after the light rays pass through the lens. As we can see from FIGS. 20A to 20D, the optical imaging lens assembly according to embodiment 10 can achieve good imaging quality.

To sum up, embodiments 1 to 10 respectively satisfy the relationships shown in Table 21.

TABLE 21

| | embodiment | | | | | | | | | |
|---|---|---|---|---|---|---|---|---|---|---|
| Conditional expression | 1 | 2 | 3 | 4 | 5 | 6 | 7 | 8 | 9 | 10 |
| ImgH (mm) | 6.45 | 6.44 | 6.42 | 6.41 | 6.40 | 6.35 | 6.38 | 6.36 | 6.30 | 6.43 |
| N1 + N2 | 3.52 | 3.52 | 3.52 | 3.52 | 3.47 | 3.51 | 3.42 | 3.50 | 3.38 | 3.50 |
| TTL/ImgH | 1.16 | 1.17 | 1.17 | 1.17 | 1.18 | 1.21 | 1.22 | 1.22 | 1.24 | 1.21 |
| V1 + V2 | 82.04 | 82.04 | 82.04 | 82.04 | 78.40 | 80.06 | 86.75 | 81.86 | 85.65 | 81.86 |
| f/(f1 + f6 + f7) | 0.79 | 0.79 | 0.80 | 0.69 | 0.75 | 0.52 | 0.91 | 0.84 | 0.85 | 0.75 |
| (R1 + R2)/(R3 + R4) | 0.69 | 0.65 | 0.52 | 0.56 | 0.76 | 0.39 | 0.50 | 0.56 | 0.50 | 0.65 |
| f7/(R13 − R14) | 0.42 | 0.43 | 0.44 | 0.44 | 0.46 | 0.33 | 0.46 | 0.45 | 0.45 | 0.45 |
| FOV (°) | 87.5 | 87.5 | 87.2 | 87.1 | 86.3 | 86.9 | 86.3 | 86.1 | 85.5 | 86.9 |
| (T45 + T56 + T67)/(CT5 + CT6 + CT7) | 1.00 | 0.99 | 0.97 | 1.01 | 1.04 | 1.13 | 0.92 | 0.84 | 0.93 | 0.90 |
| (DT11 + DT12)/ImgH × 5 | 2.51 | 2.59 | 2.53 | 2.53 | 2.55 | 2.53 | 2.61 | 2.61 | 2.64 | 2.58 |

The preferred embodiments and technical principles of the disclosure are described herein. Those skilled in the art will understand that the scope of invention referred to in the disclosure is not limited to technical solutions formed by specific combinations of the above technical features, but also should cover other technical solutions formed by arbitrary combinations of the above technical features or their equivalent features without departing from the inventive concept, for example, the technical solutions formed by replacing the above features with (but not limited to) the technical features with similar functions disclosed in the disclosure.

What is claimed is:

1. An optical imaging lens assembly, sequentially comprising the followings from an object side to an image side along an optical axis:
a first lens having a positive focal power, wherein an object-side surface thereof is a convex surface, and an image-side surface thereof is a concave surface;
a second lens having a focal power;
a third lens having a focal power;
a fourth lens having a focal power;
a fifth lens having a focal power;
a sixth lens having a positive focal power; and
a seventh lens having a negative focal power, wherein an object-side surface thereof is a concave surface, and an image-side surface thereof is a concave surface; and
DT11 is a maximum effective radius of the object-side surface of the first lens, DT12 is a maximum effective radius of the image-side surface of the first lens, and ImgH is a half of a diagonal length of an effective pixel region on an imaging surface of the optical imaging lens assembly, DT11, DT12 and ImgH meet:
2.4<(DT11+DT12)/ImgHx5<2.7.

2. The optical imaging lens assembly according to claim 1, wherein ImgH meets: ImgH>6.2 mm.

3. The optical imaging lens assembly according to claim 1, wherein a refractive index N1 of the first lens and a refractive index N2 of the second lens meet:
N1+N2>3.3.

4. The optical imaging lens assembly according to claim 1, wherein TTL is a distance from the object-side surface of the first lens to the imaging surface of the optical imaging lens assembly on the optical axis and ImgH meet:
TTL/ImgH<1.25.

5. The optical imaging lens assembly according to claim 1, wherein an Abbe number V1 of the first lens and an Abbe number V2 of the second lens meet:
78<V1+V2<88.

6. The optical imaging lens assembly according to claim 1, wherein a total effective focal length f of the optical imaging lens assembly, an effective focal length f1 of the first lens, an effective focal length f6 of the sixth lens, and an effective focal length f7 of the seventh lens meet:
0.5<f/(f1+f6+f7)<1.0.

7. The optical imaging lens assembly according to claim 1, wherein a curvature radius R1 of the object-side surface of the first lens, a curvature radius R2 of the image-side surface of the first lens, a curvature radius R3 of an object-side surface of the second lens, and a curvature radius R4 of an image-side surface of the second lens meet:
0.3<(R1+R2)/(R3+R4)<0.8.

8. The optical imaging lens assembly according to claim 1, wherein the effective focal length f7 of the seventh lens, a curvature radius R13 of the object-side surface of the seventh lens, and a curvature radius R14 of the image-side surface of the seventh lens meet:
0.2<f7/(R13−R14)<0.6.

9. The optical imaging lens assembly according to claim 1, wherein FOV is a maximum field of view of the optical imaging lens assembly meets:
82°<F0V<88°.

10. The optical imaging lens assembly according to claim 1, wherein a distance T45 between the fourth lens and the fifth lens on the optical axis, a distance T56 between the fifth lens and the sixth lens on the optical axis, a distance T67 between the sixth lens and the seventh lens on the optical axis, a center thickness CT5 of the fifth lens on the optical axis, a center thickness CT6 of the sixth lens on the optical axis, and a center thickness CT7 of the seventh lens on the optical axis meet 0.8<(T45+T56+T67)/(CT5+CT6+CT7)<1.2.

11. The optical imaging lens assembly according to claim 1, wherein at least one of the first lens to the seventh lens is made of glass.

12. An optical imaging lens assembly, sequentially comprising the followings from an object side to an image side along an optical axis:
a first lens having a positive focal power, wherein an object-side surface thereof is a convex surface, and an image-side surface thereof is a concave surface;
a second lens having a focal power;
a third lens having a focal power;
a fourth lens having a focal power;
a fifth lens having a focal power;
a sixth lens having a positive focal power; and
a seventh lens having a negative focal power, wherein an object-side surface thereof is a concave surface, and an image-side surface thereof is a concave surface; and
an Abbe number V1 of the first lens and an Abbe number V2 of the second lens meet:
78<V1+V2<88.

13. (canceled)

14. (canceled)

15. (canceled)

16. (canceled)

17. (canceled)

18. (canceled)

19. (canceled)

20. (canceled)

21. (canceled)
